(19) United States
(12) Patent Application Publication
(10) Pub. No.: US 2024/0271679 A1
(43) Pub. Date: Aug. 15, 2024

(54) Multiple Stage Air Shock

(71) Applicant: Ronald Scott Bandy, Visalia, CA (US)

(72) Inventor: Ronald Scott Bandy, Visalia, CA (US)

(21) Appl. No.: 18/414,117

(22) Filed: Jan. 16, 2024

Related U.S. Application Data
(63) Continuation-in-part of application No. 17/589,877, filed on Jan. 31, 2022, now Pat. No. 11,892,053.
Application No. 17/589,877 is a continuation of application No. 16/177,306, filed on Oct. 31, 2018, now Pat. No. 11,236,797.
Application No. 16/177,306 is a continuation of application No. 14/935,423, filed on Nov. 8, 2015, now Pat. No. 10,161,473.
Application No. 14/935,423 is a continuation-in-part of application No. 13/854,055, filed on Mar. 30, 2013, now abandoned.

(51) Int. Cl. F16F 9/32; F16F 9/00; F16F 9/02; F16F 9/06

(52) U.S. Cl. CPC F16F 9/3271; F16F 9/006; F16F 9/0209; F16F 9/0236; F16F 9/06; B60G 2202/152; B60G 2206/82; F16F 2226/04; F16F 2238/02

(57) ABSTRACT

The present invention discloses the unique dampening and suspension spring characteristics of the multiple stage air shock. Each stage can be set up with a different dampening and suspension spring characteristic. The different dampening and suspension spring characteristic for each stage furnishes the multiple stage air shock with a plurality of dampening and suspension spring characteristics, thereby enabling the multiple stage air shock to respond to different road conditions and obstacles.

### RELATED APPLICATIONS

This application is a continuation-in-part, and claims the benefit of priority to U.S. patent application Ser. No. 17/589,877 entitled “Multiple Stage Air Shock” filed on Jan. 31, 2022 and currently co-pending which in turn claims priority to U.S. patent application Ser. No. 16/177,306 filed on Oct. 31, 2018 entitled “Multiple Stage Air Shock”, which in turn claims priority to U.S. patent application Ser. No. 14/935,423 filed on Nov. 8, 2015 entitled “Process for Constructing the Multiple Stage Air Shock” which in turns claims priority to U.S. patent application Ser. No. 13/854,055 filed on Mar. 30, 2013 entitled “Segmented Air Shock”.

### BACKGROUND OF THE INVENTION

In connection with our investigation of the independent and solid axle suspension systems for four wheel drive vehicles, which are disclosed in U.S. patent application Ser. Nos. 14/059,062 and 14/324,105, respectively, we sought a shock absorber with unique compressed length and extended length properties. A survey of the art uncovered one feature common to virtually all shock absorbers—the extended length is less than twice the compressed length. This feature results from the inherent design of a shock absorber, namely, a single shaft that travels into and out of a single working tube. The length of the shaft defines the shock's travel. A shaft length of 6-8 inches is common and adequate for most vehicles. Such shocks have a relatively short compressed length thereby easing installation on production-based vehicles. However, in the off-road environment, a vehicle routinely encounters trail obstacles—e.g., boulders, fallen trees, ravines, cliffs—that exceed the limit of shock travel. To contend with such obstacles, engineers have designed long travel shocks with 12 inches or more of shaft length. These shocks require a working tube length at least equal to their shaft length. To account for the working piston, the working tube length of these shocks can be several inches longer than their shaft length—at least 14 inches or more. Such shocks have a relatively long compressed length thereby hampering installation on production-based vehicles. Typical methods of dealing with long travel shock issues include allowing the upper portion of the shock to protrude through the hood of the vehicle (for front shocks), or to protrude into the bed or trunk of the vehicle (for rear shocks). Such intrusive methods of installation are not practical for our needs, nor for production-based vehicles. Rather, our attention was drawn to a concept for a shock absorber whose extended length is greater than twice its compressed length. Moreover, given that many types of production-based vehicles are routinely used in industries that involve off-road driving, e.g., construction, farming and ranching, mining, forestry, gas and oil exploration, then automobile manufacturers and numerous other industries would greatly benefit from a long travel shock that could be easily installed on production-based vehicles

A technique for resolving long travel shock issues would involve a shock with a relatively short compressed length and a relatively long travel length. Conceptually, this technique would require a shock that could extend several times greater than just twice its compressed length. A shock whose shaft would push down completely into a working tube of the same length thus giving a fully compressed shock; and, then push out of and seemingly grow several times greater than the working tube thus giving a fully extended shock whose length is several times greater than its compressed length.

In principle, a shock whose shaft was segmented like a simple telescope or spyglass could extend many times beyond its original compressed length. This principle refers to a design that consists of more than one independent shock-unit operating in series where the working tube for one shock-unit serves as the shaft for the next larger shock-unit, and so on. This design would have one shock-unit pushing down into the next larger one, and so on, so that by ignoring end caps and working pistons, the length of just one (the largest) working tube is representative of the shock's compressed length while the number of shock-units used in the shock's construction is representative of its extended length—e.g., three shock-units could extend three times beyond the compressed length, four shock units could extend four times beyond the compressed length, and so on—in effect, a shock within a shock. This shock within a shock design is ideally suited for our needs, and for installation on production-based vehicles thereby fulfilling the need of numerous industries that would benefit from a long travel shock with a short compressed length.

During the course of our investigation, it was brought to our attention that the shock within a shock design is known in the art as a multiple stage shock absorber. Therefore, our investigation was re-focused on developing a process for constructing this shock absorber. The construction process comprises novel means that are absent in the art, including means for adding stages to the shock, determining various lengths for the shock, and determining various spring rates for the shock.

The multiple stage air shock features unique properties. These properties include an extended length that is greater than twice its compressed length, linear spring rate, and the capability to respond to different road conditions. The first property is discussed in U.S. patent application Ser. No. 16/177,306, the second property is discussed in U.S. patent application Ser. Nos. 17/589,877 and 14/935,423, while the third property is discussed in U.S. patent application Ser. No. 13/854,055 and will be discussed throughout this specification.

In the art, a shock absorber acts to resist or dampen the suspension spring's oscillation, which improves the vehicle's ride and handling. Dampening is characterized by the flow of oil within the shock's working parts, e.g., working piston, and working tube or reservoir.

Efforts to control the flow of oil has led to shock absorbers being classified into three different categories: active, semi-active, and passive. Active and semi-active shock absorbers are capable of changing their dampening characteristics. The ability to change their dampening characteristics allows both active and semi-active shocks to accommodate different types of road conditions, which improves handling and performance. A system of sensors, microprocessors, and actuators are used to transform data about the road into an optimized dampening characteristic for the condition.

The difference between the active and semi-active shock is that the active shock is able to change the suspension spring force while the semi-active shock cannot change the suspension spring force. The suspension spring force is changed in coordination with the dampening characteristic. Coordination between the suspension spring force and dampening characteristic enables the active shock to provide the optimal suspension response for the road condition, thereby resulting in the best handling and performance for the vehicle.

Passive shocks have a fixed dampening characteristic that is based on the design of the shock. The fixed characteristic accommodates a limited range of road conditions; which limits the handling and performance in comparison to handling and performance characteristics of the active and semi-active counterparts. Even though handling and performance characteristics of passive shocks are lower, they are still an attractive option for manufacturers of vehicles because most commonly-traveled roads represent relatively uniform conditions. Passive shocks are inexpensive, easy to make, rugged, and reliable devices. Conversely, active and semi-active shocks are expensive, complex, less reliable, and not widely available. In particular, active shocks refer to a suspension system comprised of electro-hydraulic or electro-magnetic actuators that draw high power from the vehicle's motor. The cost, complexity, and high-power draw restricts the suitability of active suspension systems and shocks to expensive sport-performance luxury street driven vehicles only.

A variety of methods have been devised to improve the dampening characteristics of passive shocks by changing the flow of oil through and around the working piston. Oil flows through the working piston by flowing through holes that are machined through the working piston, where the holes are known as orifices.

There are two common methods of changing the flow of oil through the working piston. The first is called deflective disc valving. This process employs the use of valves and shims, which are thin washer shaped disks that may contain holes of different sizes and shapes, positioned against the working piston and control the flow of oil through the working piston. The second is called Acceleration Sensitive Damping (ASD) which employs the use of special compression valves that enable the oil to bypass the working piston via a closed loop system.

There are two common methods of changing the flow of oil around the working piston. The first is a process called Position Sensitive Damping (PSD), popularly known as internal bypass valving, which allows the oil to bypass the working piston because of tapered groves that are machined onto the inside of the wall of the working tube. The second is known as external bypass valving which allows the oil to bypass the working piston through holes that are drilled through the walls of the working tube and connected to long thin tubes located outside the working tube.

A more recent method of changing the flow of oil through the working piston is a type of spool valve dampening. Pioneered by Multimatic, Inc. and called dynamic suspensions spool valve (DSSV), the traditional shims “are replaced with a pair of hollow cylindrical sleeves nested concentrically within each other and held apart by a coil spring.” Don Sherman, From F1 to Baja: Multimatic's Clever Spool—Valve Dampers Explained, Car and Driver (Dec. 9, 2016), https://www.caranddriver.com/news/a15344953/from-f1-to-baja-multimatics-clever-spool-valve-dampers-explained/. Although the DSSV is a passive shock, it is still capable of being tuned for different types of road conditions. Thus, the DSSV offers the handling and performance of semi-active shocks without the cost, complexity, and unreliability of semi-active shocks.

The multiple stage air shock falls into the passive shock category, but is capable of adapting to different road conditions. The dampening characteristic is based on the traditional working piston and shims. The working piston and shims in one stage are able to be different than those in the other stages, thereby enabling each stage to have a different dampening characteristic. The different dampening characteristic enables each stage to respond to a different road condition. This way, the multiple stage air shock can have different dampening characteristics that respond to different road conditions.

As an air shock, the multiple stage air shock can act as a suspension spring. Each stage functions as an independent shock-unit and has a gas charge. The gas charge refers to gas pressure. The gas pressure enables each stage to have a suspension spring force that supports the weight of the vehicle and responds to the road condition. The gas charge for each stage can be different such that the suspension spring force for each stage is different and responds to a different road condition. This way, the multiple stage air shock can have different suspension spring forces that respond to different road conditions.

Each stage can be set up such that its suspension spring force is coordinated with its dampening characteristic. Therefore, the multiple stage air shock can have different suspension spring forces and dampening characteristics, whereby each suspension spring force can be coordinated with its respective dampening characteristic—i.e., the multiple stage air shock can have a plurality of coordinated suspension spring forces and dampening characteristics. The plurality of coordinated suspension spring forces and dampening characteristics means that the multiple stage air shock can provide the optimal suspension response for any given road condition, thereby resulting in the best handling and performance for the vehicle. Consequently, the multiple stage air shock is a passive shock that possesses the unique capability of behaving similarly to an active shock.

### BRIEF SUMMARY OF THE INVENTION

The present invention offers a process for constructing the multiple stage shock absorber. The multiple stage shock absorber is defined in terms of the multiple stage air shock. The multiple stage air shock was initially disclosed in U.S. patent application Ser. No. 13/854,055 filed on Mar. 30, 2013, and serves as the basis for developing the process. The process includes means for adding stages, determining compressed lengths, extended lengths, optimized lengths, and estimation of linear spring rates.

The present invention also describes another multi-step process. The first step is a method of adding more stages to the multiple stage air shock. The addition is based on adding a new first stage and involves the re-specification of the components in the existing stages. The second step is a method of determining the compressed and extended lengths of the multiple stage air shock which is based on a first methodology. The first methodology uses equations to compute the dimensions of the parts for each stage whereby various dimensions used in constructing each stage can be applied to a second methodology for estimating a linear spring rate. The first methodology allows the extended length to be greater than twice the compressed length, thereby producing a long travel multiple stage air shock with a short compressed length. The extended length is computed in terms of the compressed length, whereby the extended length reaches a maximum value (optimized extended length) and then subsequently decreases as stages are added to the multiple stage air shock. The third step involves a method of making the spring rate relatively linear through the use of the second methodology.

The second methodology provides a set-up for the multiple stage air shock that is based on a graphical analysis of the operation of each stage. The graphical analysis describes the operation of each stage with a curved line, which in turn results in describing the operation of the multiple stage air shock as a series of intersecting curved line parts and a specification of the gas charge for each stage necessary to set-up the shock. A line traced along the series of intersecting curved line parts represents an estimate of the spring rate for the multiple stage air shock, the straighter the line trace, the more linear the spring rate. The second methodology also includes a method of making the spring rate more linear by adding more stages to the multiple stage air shock.

The multiple stage air shock also possesses a highly refined tuning capability. Each stage can be set up with a different gas charge and dampening characteristic. The gas charge refers to a suspension spring force which can be coordinated with the dampening characteristic, and thereby provides the multiple stage air shock with the capability to respond to different road conditions and obstacles.

### BRIEF DESCRIPTION OF THE DRAWINGS

For purposes of discussion, for drawings illustrated in the plan view, the end cap is shown as two small parts at the open end of a component so that the shaft is fully exposed. This way, the features of the shaft are easier to view and understand. In contrast, for drawings illustrated in the side perspective view, the end cap is shown as a single part at the open end of a component in order to enhance the cylindrical shape of the air shock. It is appreciated that these drawings depict only illustrated embodiments of the invention and are therefore not limited to the precise arrangements and instrumentalities shown:

FIG. 1 is a side plan view of the working tube;

FIG. 2 is a side perspective view of the working tube;

FIG. 3 is a plan, top, and side perspective views of the end cap;

FIG. 4 is a side plan view of the single function shaft;

FIG. 5 is a side plan view of the dual function shaft;

FIG. 6 is a side perspective view of the single function shaft;

FIG. 7 is a side perspective view of the dual function shaft;

FIG. 8 is a side plan view of the disk and shims for the working piston;

FIG. 9 is a side perspective view of the disk and shims for the working piston;

FIG. 10 is a side plan view of the working piston;

FIG. 11 is a side perspective view of the working piston;

FIG. 12 is a plan view of the stage comprising the working tube and dual function shaft;

FIG. 13 is a plan view of the stage comprising two dual function shafts;

FIG. 14 is a side perspective view of the stage that comprises the working tube and dual function shaft;

FIG. 15 is a side perspective view of the stage that comprises two dual function shafts;

FIG. 16 is a plan view of the stage that comprises dual and single function shafts undergoing compression;

FIG. 17 is a plan view of the stage that comprises dual and single function shafts undergoing extension;

FIG. 18 is a plan view of the stage that comprises dual and single function shafts at full compression;

FIG. 19 is a plan view of the stage that comprises dual and single function shafts at full extension;

FIG. 20 is a side perspective view of the stage that comprises dual and single function shafts at full compression;

FIG. 21 is a side perspective view of the stage that comprises dual and single function shafts at full extension;

FIG. 22 is a plan view of the three stage air shock at full extension;

FIG. 23 is a plan view of the four stage air shock at full extension;

FIG. 24 is a plan view of the five stage air shock at full extension;

FIG. 25 is a plan view of the four stage air shock at full extension, spaces are identified;

FIG. 26 is a plan view of the four stage air shock at full compression, check valves are identified;

FIG. 27 is a side perspective view of the four stage air shock at full extension;

FIG. 28 is a side perspective view of the four stage air shock at full compression;

FIG. 29 is a plan view of the four stage air shock in which the first and second stages are at full extension and the third and fourth stages are at partial compression;

FIG. 30 is a side perspective view of the four stage air shock in which the first and second stages are at full extension and the third and fourth stages are at partial compression;

FIG. 31 is a plan view of the three stage air shock at full compression;

FIG. 32 is a plan view of the three stage air shock transforming to the four stage air shock;

FIG. 33 is a plan view of the four stage air shock at full compression;

FIG. 34 is a plan view of the four stage air shock transforming to the five stage air shock;

FIG. 35 is a plan view of the five stage air shock at full compression;

FIG. 36 is a plan view of the two stage air shock at full compression emphasizing a constant compressed length;

FIG. 37 is a plan view of the three stage air shock at full compression emphasizing a constant compressed length;

FIG. 38 is a plan view of the four stage air shock at full compression emphasizing a constant compressed length;

FIG. 39 is a plan view of the five stage air shock at full compression emphasizing a constant compressed length;

FIG. 40 is an algorithm including a plan view of the three stage air shock at full compression emphasizing computation of the relationships among the lengths/shaft strokes of the components for each stage;

FIG. 41 is a plan view of the four stage air shock at full extension emphasizing the lengths of the air shock and parts of each stage;

FIG. 42 is a plan view of the four stage air shock at full compression emphasizing the length of the air shock;

FIG. 43 is an equation used to compute the length of the working tube L_{X+1} for the multiple stage air shock comprising X+1 stages where X=1-7;

FIG. 44 is an equation used to compute the lengths of the nth dual function shafts L_{Wn} for the multiple stage air shock comprising X stages where n=1, 2, . . . , X−1 and X=2-8;

FIG. 45 is an equation used to compute the shaft stroke for the first stage L_{S1} for the multiple stage air shock comprising X stages where X=1-8;

FIG. 46 is an equation used to compute the shaft stroke for the nth stage L_{Sn} for the multiple stage air shock comprising X stages where n=2, 3, . . . , X and X=2-8;

FIG. 47 is an equation used to compute the compressed length CL_{X} for the multiple stage air shock comprising X stages where X=1-8;

FIG. 48 is an equation used to compute the extended length EL_{X} for the multiple stage air shock comprising X stages where X=1-8;

FIG. 49 shows the selected value for the mounting eyelet me;

FIGS. 50-57 are tables of the selected values for wpₙ, ssₙ, and ecₙ for the nth stage for the multiple stage air shock comprising X stages where n=1, 2, . . . , X and X=1-8;

FIGS. 58-60 are tables of the computed values for L_{X}, L_{W1-7}, L_{S1-8}, CL_{X}, EL_{X}, and EL_{X}/CL_{X} for the multiple stage air shock comprising X stages where X=1-8 and L₁ is a selected value;

FIG. 61 is a table of the computed values for the optimum extended length EL_{MAX} for the multiple stage air shock comprising X stages where X=4-6;

FIG. 62 is a partial plan view of the stage that comprises a component and shaft at full extension;

FIG. 63 is a plan view of the stage that comprises a component and shaft at full compression;

FIG. 64 is a plan view of the stage that comprises a component and shaft at full compression emphasizing the volume of the shaft;

FIG. 65 is a plan view of the stage that comprises a component and shaft at full compression emphasizing the volumes of the oil and gas;

FIG. 66 is an equation used to compute the area of the working tube, or first, second, or third dual function shaft or area of the first, second, or third dual function shaft stroke or single function shaft stroke, Aₙ;

FIG. 67 is an equation used to compute the volume of the working tube, or first, second, or third dual function shaft, Vₘ;

FIG. 68 is an equation used to compute the volume of the first, second, or third dual function shaft stroke or single function shaft stroke, Vₙ;

FIG. 69 is an equation used to compute the volume of the gas charge for the first, second, third, or fourth stage, V_{Gt};

FIG. 70 is an equation used to compute the volume of the oil charge in cubic inches for the first, second, third, or fourth stage, V_{Ot} (in³);

FIG. 71 is an equation used to compute the volume of the oil charge in cubic centimeters for the first, second, third, or fourth stage, V_{Ot} (cc);

FIG. 72 is an equation used to compute the shaft stroke at ride height for the first, second, third, or fourth stage, Lₜ;

FIG. 73 is an equation used to compute the volume of the shaft stroke at ride height for the first, second, third, or fourth stage, Vₜ;

FIG. 74 is an equation used to compute the gas charge at ride height for the first, second, third, or fourth stage, P_{Gt};

FIG. 75 is an equation used to compute the constant in Boyle's Law for the first, second, third, or fourth stage, cₜ;

FIG. 76 is an equation used to compute the volume of the stage at the selected incremental shaft stroke for the first, second, third, or fourth stage, V_{Z};

FIG. 77 is an equation used to compute the gas pressure at the selected incremental shaft stroke for the first, second, third, or fourth stage, P_{Z};

FIG. 78 is an equation used to compute the suspension force at the selected incremental shaft stroke for the first, second, third, or fourth stage, F_{Z};

FIG. 79 is an equation used to compute the spring rate at the selected incremental shaft stroke for the first, second, third, or fourth stage, SR_{Z};

FIG. 80 is an equation used to compute the percent change in incremental shaft stroke at the selected incremental shaft stroke for the first, second, third, or fourth stage, % ΔL_{Z};

FIG. 81 is an equation used to compute the percent change in gas pressure at the selected incremental shaft stroke for the first, second, third, or fourth stage, % ΔP_{Z};

FIG. 82 is an equation used to compute the percent change in spring rate at the selected incremental shaft stroke for the first, second, third, or fourth stage, % ΔSR_{Z};

FIG. 83 is an equation used to compute the change in incremental shaft stroke at the selected incremental shaft stroke for the first, second, third, or fourth stage, ΔL_{Z};

FIG. 84 is a table of the selected values for D_{W}, Dₙ, L_{W}, Lₙ, % Lₜ, and Fₜ where n=D1, D2, D3, or S1 and t=1-4, respectively;

FIG. 85 is a table of the computed values for A_{W}, Aₙ, Vₘ, Vₙ, V_{Gt}, V_{Ot}(in), V_{Ot}(cc), and cₜ where m=W, W1, W2, or W3, n=D1, D2, D3, or S1, and t=1-4, respectively;

FIG. 86 is a table of the computed values for Lₜ, Vₜ, and Pot where t=1-4;

FIG. 87 is a table of the computed values for V₁ₑ, P₁ₑ, F₁ₑ, % ΔL₁ₑ, % ΔP₁ₑ, SR₁ₑ, % ΔSR₁ₑ, and selected value for L₁ₑ where 1e refers to the first stage;

FIG. 88 is a table of the computed values for V_{2f}, P_{2f}, F_{2f}, % ΔL_{2f}, % ΔP_{2f}, SR_{2f}, % ΔSR_{2f}, and selected value for L_{2f} where 2f refers to the second stage;

FIG. 89 is a table of the computed values for V_{3g}, P_{3g}, F_{3g}, % ΔL_{3g}, % ΔP_{3g}, SR_{3g}, % ΔSR_{3g}, and selected value for L_{3g} where 3g refers to the third stage;

FIG. 90 is a table of the computed values for V₄ₕ, P₄ₕ, F₄ₕ, % ΔL₄ₕ, % ΔP₄ₕ, SR₄ₕ, % ΔSR₄ₕ, and selected value for L₄ₕ where 4h refers to the fourth stage;

FIG. 91 is a table of the computed values for % ΔL₁ₑ, F₁ₑ, ΔL₁ₑ, SR₁ₑ and selected value for L₁ₑ where 1e refers to the first stage;

FIG. 92 is a table of the computed values for % ΔL_{2f}, F_{2f}, ΔL_{2f}, SR_{2f}, and selected value for L_{2f} where 2f refers to the second stage;

FIG. 93 is a table of the computed values for % ΔL_{3g}, F_{3g}, ΔL_{3g}, SR_{3g}, and selected value for L_{3g} where 3g refers to the third stage;

FIG. 94 is a table of the computed values for % ΔL₄ₕ, F₄ₕ, ΔL₄ₕ, SR₄ₕ, and selected value for L₄ₕ where 4h refers to the fourth stage;

FIG. 95 is a graph of the curved lines of suspension force F₁₋₄ vs change in incremental shaft stroke L₁₋₄ for the first, second, third, and fourth stages;

FIG. 96 is an illustration of a curved line tangent to a straight line;

FIG. 97 is a graph of the curved lines of spring rate SR₁₋₄ vs change in incremental shaft stroke L₁₋₄ for the first, second, third, and fourth stages in which a disjointed jagged dotted line is traced over a part of each curved line;

FIG. 98 is an illustration of the curved lines for four stages tangent to a straight line;

FIG. 99 is a graph of the curved lines of suspension force F₁₋₄ vs change in incremental shaft stroke L₁₋₄ for the first, second, third, and fourth stages in which a dotted line is traced over a part of each curved line;

FIG. 100 is an illustration of a set of three circles, each circle represents a curved line for a stage in a three stage air shock, the illustration emphasizing the size of the curved line part of each stage;

FIG. 101 is an illustration of a set of four circles, each circle represents a curved line for a stage in a four stage air shock, the illustration emphasizing the size of the curved line part of each stage;

FIG. 102 is an illustration of a set of five circles, each circle represents a curved line for a stage in a five stage air shock, the illustration emphasizing the size of the curved line part of each stage.

### DETAILED DESCRIPTION

Discussed herein is a process suitable for constructing the multiple stage air shock. While the multiple stage design is known in the art, our investigation uncovered characteristics about the design that are absent in the art. These characteristics define a process for constructing an air shock with the multiple stage design. The multiple stage air shock that is disclosed in U.S. patent application Ser. No. 13/854,055 filed on Mar. 30, 2013 is representative of the multiple stage design and is intended to serve as the basis for the present invention. The construction process includes means for adding stages to the multiple stage air shock, determining the compressed, extended, and optimized extended lengths for the multiple stage air shock, and determining relatively linear spring rates for the multiple stage air shock. To exemplify the present invention, the multiple stage air shock comprising four stages, and its individual parts are described in detail.

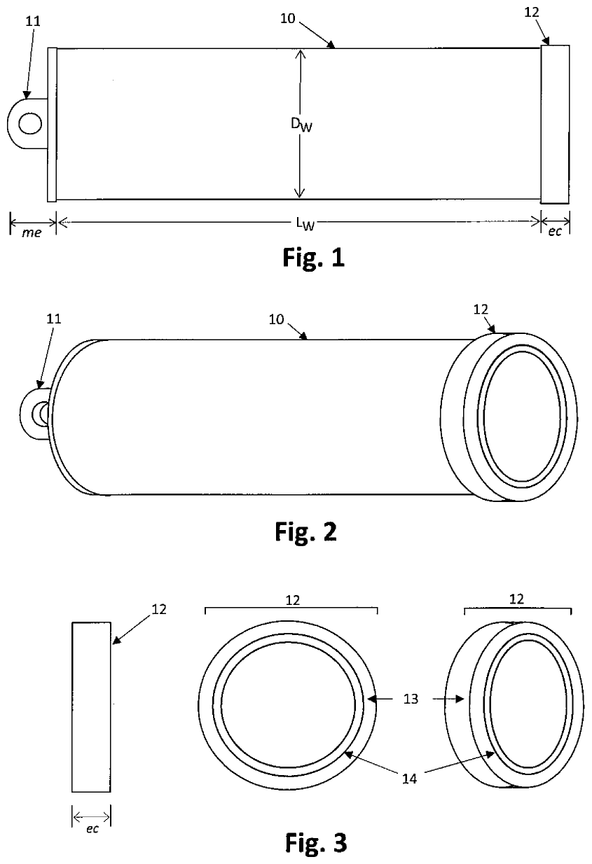

Referring initially to FIGS. 1-3, the working tube 10 is illustrated in detail. The working tube 10 is a thin-walled cylinder and is constructed out of metal such as aluminum. The working tube has a diameter D_{W}, length L_{W}, a closed first end and an open second end. The closed end is attached to a mounting eyelet 11, while the open end is attached to an end cap 12. The end cap 12 has a composite construction that includes a metal part 13, made out of a material such as aluminum, and a flexible material part 14, that is made out of a material such as rubber. The end cap 12 has the structure of a thick ring. The end cap 12 has a thickness ec, whereby the metal part 13 serves to attach the end cap 12 to the working tube 10, while the flexible material part 14 serves as a seal and operates in a similar manner to a torus gasket. The mounting eyelet 11 has a thickness me and is what allows the air shock to be attached to a suspended part of the vehicle.

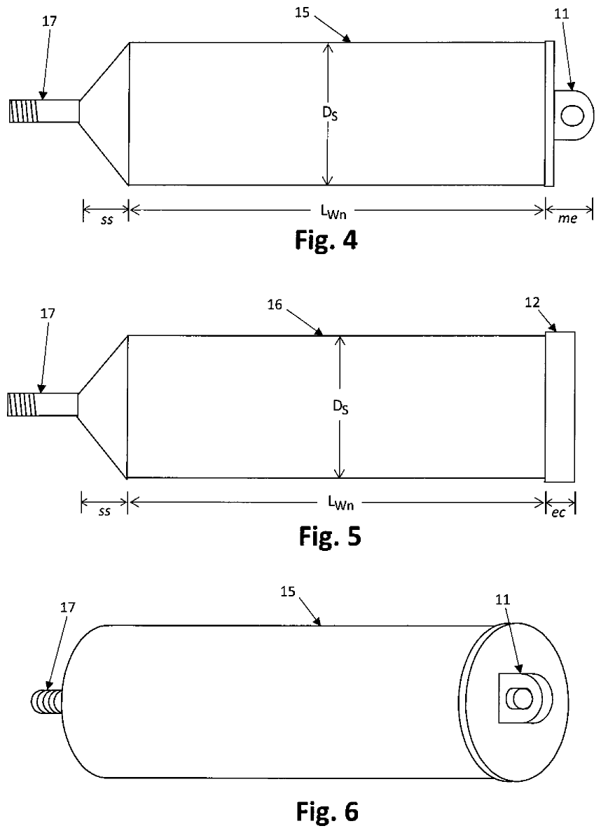

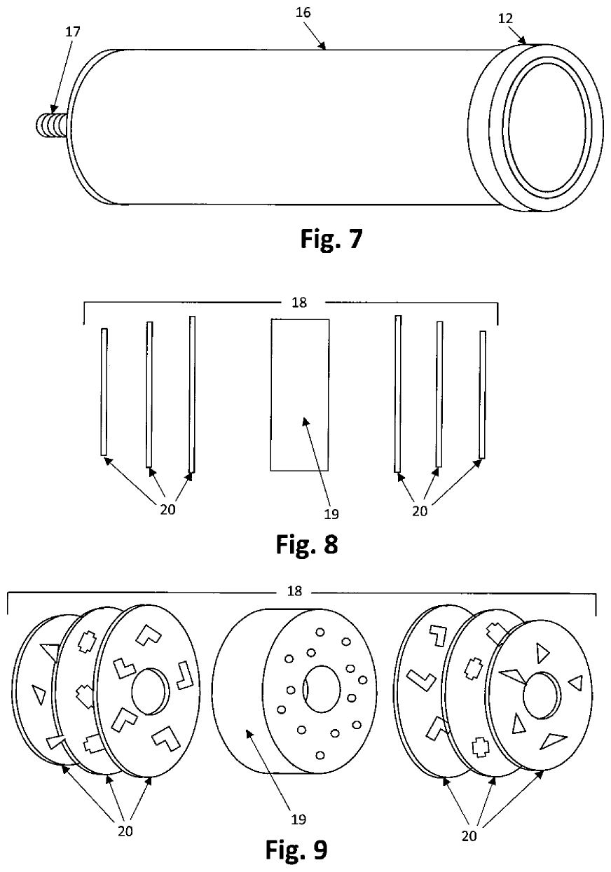

Referring now to FIGS. 4-7, the shaft is illustrated in detail. The shaft is a thin-walled cylinder that is constructed out of metal such as aluminum. The shaft has a diameter D_{S}, length L_{Wn}, closed first end, and a second end that can be either opened or closed. The first end is narrowed down to form a threaded shank 17. The narrowed down part is made up by a shaft shoulder and has a thickness ss, while the threaded shank 17 serves as a fastener for a working piston. When the second end is closed the shaft is a single function shaft 15 because the second end is attached to a mounting eyelet 11, which allows the air shock to be attached to a non-suspended part of the vehicle. When the second end is open, the shaft is a dual function shaft 16 because the second end is attached to the end cap 12.

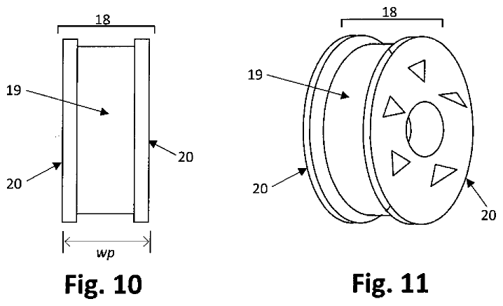

Referring now to FIGS. 8-11, the working piston 18 is illustrated in detail. The working piston 18 has a composite construction that includes a disk 19 and shims 20. The disk 19 is made from a hardened material such as aluminum or plastic, and has a similar structure of a thick circular bushing. The disk 19 has a large hole in the center and smaller surrounding holes, whereby the center hole fits over the threaded shank 17 such that the working piston 18 can be attached to the shaft. The shims 20 are made from steel or aluminum in the shape of thin, flat, round, washers. The shims 20 can have varying holes, diameters, and thicknesses. Additionally, the shims 20 are arranged sequentially on each side of the disk 19 whereby the combination of the disk and shims gives the working piston 18 a thickness wp.

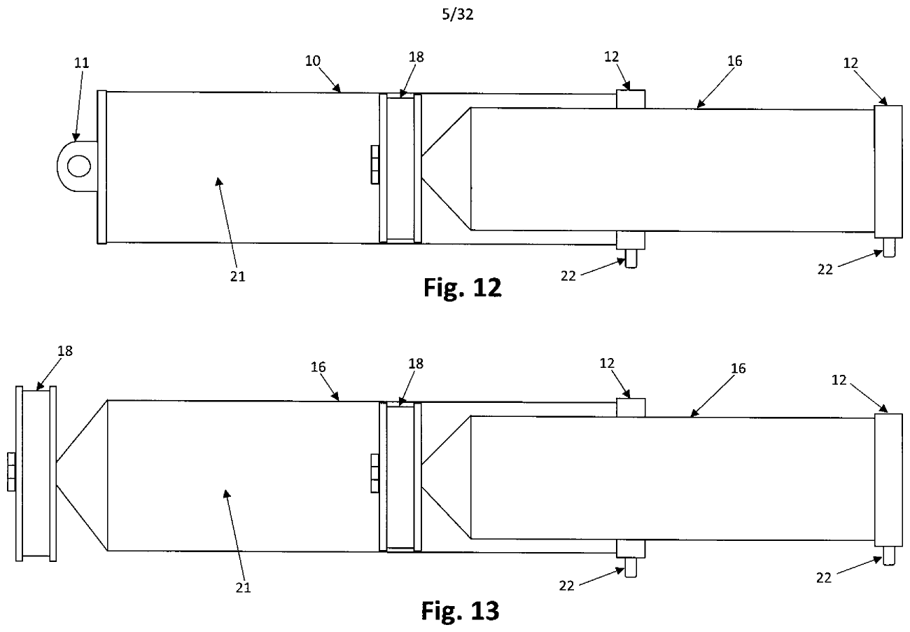

Referring now to FIGS. 12-21, the stage is illustrated in detail. A stage refers to a first and the second interconnected components. The first component can be either a single 15 or dual function shaft 16, while the second component is either the dual function shaft 16 or working tube 10. The interconnection refers to the first closed end of the first component being slidably inserted through the end cap 12 and into the open end of the second component. The working piston 18 is attached to the first closed end of the first component while the end cap 12 is attached to the open end of the second component. The first component is able to slide in and out of the second component due to the cooperative guidance of the working piston 18 and end cap 12. The insertion of the first component into the second component defines a space 21 within the second component, whereby the space 21 is between the closed end and end cap 12. The space 21 has a volume and is the volume of the stage. The end cap 12 is equipped with a check valve 22 that permits oil and gas to be added to or removed from the second component. The addition of a given amount of oil or gas refers to the oil or gas charge, respectively. This way, the space 21 within the second component is occupied by the oil and gas, whereby the sealing action of the end cap 12 confines the oil and gas to the space 21. The confinement allows the oil to have a volume and the gas to have both a volume and pressure.

Road obstructions encountered by the vehicle refer to forces that act on the suspension system and cause the suspension system to move. These forces are referred to as suspension forces, and are transferred from the vehicle to the air shock and then to the stage. The suspension forces exerted on the stage cause the one component to slide into or out of the second component.

Referring to FIGS. 9, 14, 15, the stage and working piston 18 are illustrated in detail.

It's well-known in the art of shock absorbers that the resistance of the shaft to slide into and out of the working tube defines the dampening characteristic of the shock. The resistance is due to the oil flow through the holes in the working piston and shims. The shims regulate the oil flow through the working piston and thereby control the dampening characteristic. The dampening characteristic can be changed by changing the dimensions of the working piston or shims, the dimensions referring to the sizes of the holes in the working piston, and the thicknesses of the shims, and sizes and shapes of the holes in the shims that contain holes.

The stage comprises the first and second components. The first component is the single or dual function shaft 15 or 16, while the second component is the dual function shaft 16 or working tube 10. Each component has a cylinder-like structure, and a first and second ends. The first end of the first component is slidably inserted into the first end of the second component. This insertion allows the first component to slide in and out of the second component. The insertion also defines a confined space 21 within the second component between the first end of the one component and second end of the second component. The confined space 21 contains both gas and oil. The working piston 18 is attached to the first end of the one component such that the sliding of the first component in and out of the second component causes the working piston 18 to slide within the confined space 21. The sliding of the working piston 18 causes the oil to flow through the holes in the working piston 18, which in turn causes the one component to resist sliding into and out of the second component. The resistance of the one component to slide into and out of the second component defines the dampening characteristic of the stage, and dampens the suspension spring motion of the stage. The suspension spring motion refers to the suspension spring force, or simply the suspension force.

The dimensions of the working piston 18 and shims 20 are fixed for each stage, thereby defining the multiple stage air shock as a passive shock. Our shims 20 are shown with holes of varying sizes and shapes, yet are able to be solid disks without holes. The dimensions of the working piston 18 and shims 20 for one stage are able to be different from those of the other stages such that each stage is able to have a working piston 18 and shims 20 with different dimensions. This way, each stage is able to have a different dampening characteristic. Therefore, the multiple stage air shock can be set up with a given number of different dampening characteristics whereby the number is equal to the number of stages comprising the shock.

It's well-known in the art of suspension systems that the type of terrain that the vehicle drives over can vary from very smooth to very rough. The type of terrain refers to the suspension spring force; the rougher the terrain, the greater is the motion of the suspension system, and the greater is the suspension spring force. The best handling for the vehicle is achieved by coordinating the dampening characteristic with the suspension spring force—the dampening characteristic is increased as the suspension spring force increases. That is, the best handling is achieved by increasing the dampening characteristic as the road condition becomes rougher—a light dampening characteristic is preferred for relatively smooth road conditions while a heavy dampening characteristic is preferred for relatively rough road conditions.

For the multiple stage air shock, the gas charge refers to the suspension spring force or suspension force, and the suspension spring force refers to the compression of the shock, and thereby the roughness of the terrain. In effect, the gas charge sets up the stage to respond to a given type of terrain or road condition—as the gas charge increases, the stage is set up to respond to a rougher road condition. Since each stage is set up with a different gas charge in order to achieve a linear spring rate, then as a routine practice the multiple stage air shock is set up to respond to different road conditions. In short, the different gas charge for each stage sets up the multiple stage air shock to possess different suspension spring forces and thereby respond to different road conditions.

Since each stage has a different gas charge and since each stage can be set up with a different dampening characteristic, then each stage can be set up with a different gas charge and dampening characteristic whereby the gas charge is coordinated with the dampening characteristic. Each stage can be set up with a different suspension spring force and dampening characteristic, whereby the suspension spring force is coordinated with the dampening characteristic. Each stage can be set up with a coordinated suspension spring force and dampening characteristic that respond to a different road condition. Each stage can be set up with a different gas charge that is coordinated with its dampening characteristic such that once the linear spring rate is achieved, the multiple stage air shock possesses different suspension spring forces and dampening characteristics that respond to different road conditions, whereby the different suspension spring forces are coordinated with the different dampening characteristics. In short, the multiple stage air shock possesses a plurality of coordinated suspension spring forces and dampening characteristics. Despite the multiple stage air shock being a passive shock by design, the capability of the multiple stage air shock to possess a plurality of coordinated suspension spring forces and dampening characteristics that respond to different road conditions indicates that the multiple stage air shock can operate like an active shock.

In summary, the multiple stage air shock is a unique and unprecedented passive shock whose properties are analogous to semi-active or active shocks—the multiple stage air shock possesses a plurality of coordinated suspension spring forces and dampening characteristics that respond to different road conditions. This unique property enables the multiple stage air shock to provide superb handling and performance for the vehicle that is unobtainable by other air shocks and passive shocks.

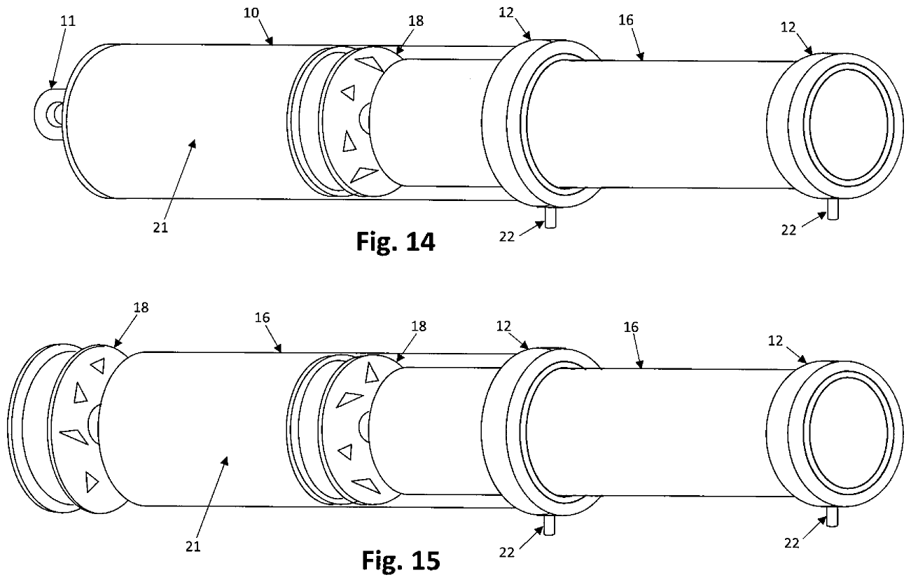

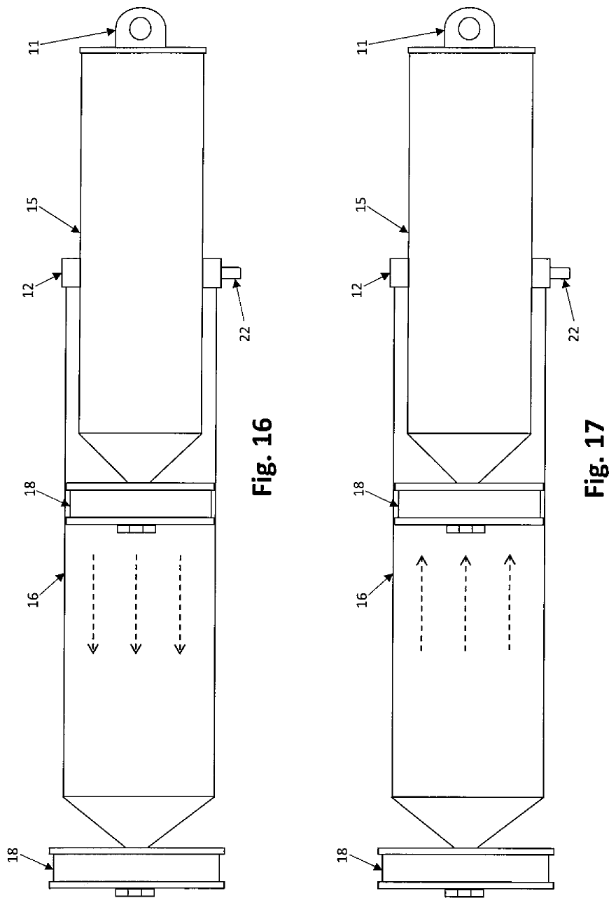

Referring now to FIGS. 16 and 17, the operation of the stage is shown. The operation of the stage refers to the action of the first component sliding in or out of the second component, whereby the compression or extension of the shaft refers to compression or extension of the stage.

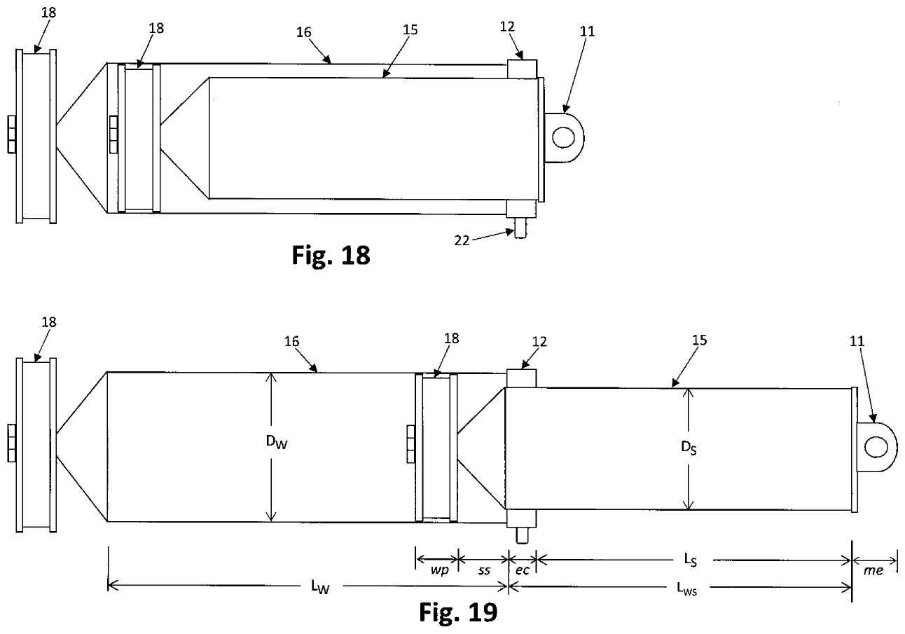

Referring now to FIG. 18 or 19, the stage in a state of full compression or extension is shown. Specific to FIG. 19, the dimensions of the parts comprising the stage are shown. The length of the shaft that protrudes out of the second component is defined as the shaft stroke L_{S}. The shaft motion is what causes a change in the volume of the second component which is occupied by the oil and gas, which in turn causes a change in the pressure of the gas. The shaft motion also results in a mixing of the oil and gas whereby the mixing of the oil and gas refers to an emulsion. The gas pressure is related to the gas charge and defines a force that is a suspension spring force. The suspension spring force provides the stage with a suspension spring capability and allows the stage both to partially support the weight of the vehicle and to also react to suspension movements. Since the suspension spring capability of the stage refers to suspension movements, which in turn cause the stage to undergo the operation of compression or extension, the suspension spring capability of the stage defines the operation of the stage such that partial compression or extension of the stage refers to part of the suspension spring capability being utilized in the operation of the stage. The part of the suspension spring capability that is utilized in the operation of the stage is dependent on the gas charge. The action of the working piston 18 sliding in or out of the second component causes the oil to flow through the holes in the working piston 18. The flow of the oil through the holes causes the working piston 18 to resist the sliding of the first component whereby the resistance acts to dampen the suspension spring motion of the stage. The shims 20 control the amount of resistance of the working piston 18 by regulating the rate of the oil flow through the holes.

The multiple stage air shock is constructed on the basis of the first and the second interconnecting components being able to belong to one and another stages, respectively, whereby the first component for the first stage is able to slide in and out of the second component for another stage such that the interconnection between the first and the second components refers to the first and another stages being interconnected in series. In order for the first component to be inserted into and then slide completely in and out of the second component, the diameter and length of the the first component must cooperate with that of the second component. Therefore, the components are interconnected according to diameter and length. Whereby the diameter of the first component with a smaller diameter is inserted into the second component with a larger diameter; and whereby the length one of the first component is shorter than the length of the second component in order to account for the thicknesses of the working piston and shaft shoulder; and the length of each single or dual function shaft refers to each single or dual function shaft stroke, respectively. Further discussion about the lengths of the first and the second components is covered in paragraph below.

In order to fully utilize the capability of the multiple stage design, the diameter of the first component must be just slightly smaller than that of the second component such that the first component is able to insert into the second component. The just slightly smaller concept allows for the maximum number of stages to be added to a shock with a given diameter for the working tube.

The sliding motion of the one component will cause a significant change in the volume of the space within the second component because the diameter of the one component is only slightly smaller than that of the second component. This change in volume must be accounted for by the gas because the oil is non-compressible. The net result is that a significant part of the space within the second component must be filled with a gas whereby the sliding motion of the one component will cause a significant change in the volume of the space which in turn will cause a significant change in the gas pressure. In the art, any shock absorber comprising a shaft whose motion causes a significant change in the volume of the space within the working tube is known as an air shock, whereby the air shock possesses both dampening and suspension spring properties, the suspension spring property being determined by the gas pressure. Therefore, by definition, any shock absorber comprising a multiple stage design must be an air shock.

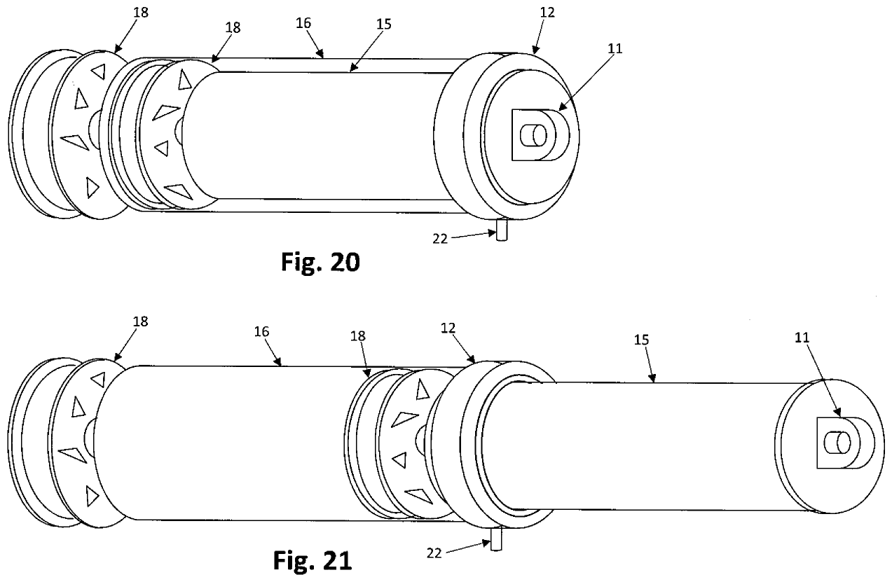

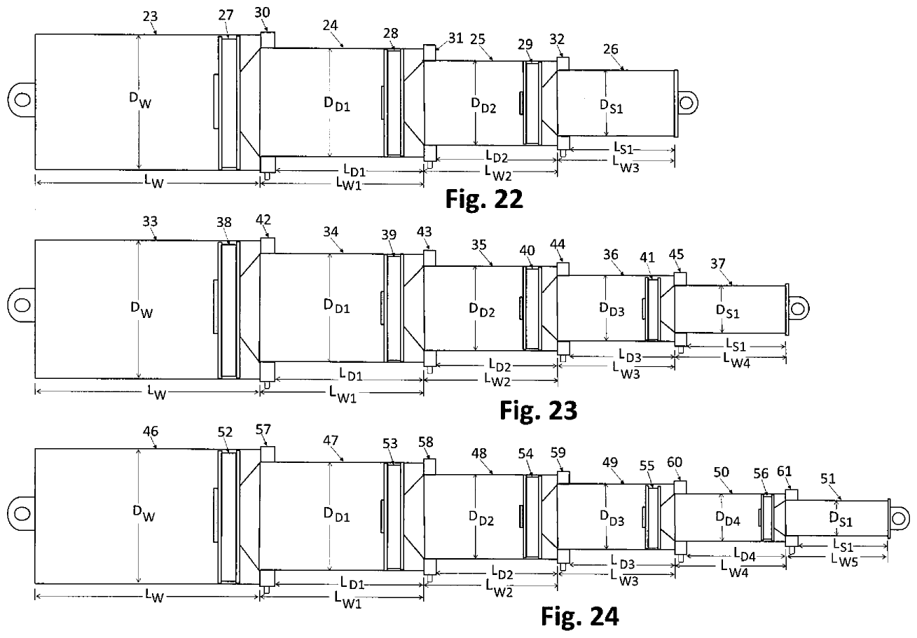

Referring now to FIGS. 22-24, symbols for the diameters and lengths of stages in the multiple stage air shock are shown; as well as a three stage shock, four stage shock, and a five stage shock. In particular, the working tube has the largest diameter and length; the diameter and length of each dual function shaft are smaller than the working tube, while the single function shaft has the smallest diameter and length. In a non-limiting example, consider a multiple stage air shock constructed with three, four, or five stages. The components of each construct are able to involve a working tube, a first dual function shaft, a second dual function shaft, a third dual function shaft, a fourth dual function shaft, and a single function shaft. For purposes of discussion, the diameters and lengths of the working tube, first dual function shaft, second dual function shaft, third dual function shaft, fourth dual function shaft, and single function shaft are defined as D_{W}, D_{D1}, D_{D2}, D_{D3}, D_{D4}, and D_{S1} and L_{W}, L_{W1}, L_{W2}, L_{W3}, L_{W4}, and L_{W5}, respectively. The shaft strokes of the first dual function shaft, second dual function shaft, third dual function shaft, fourth dual function shaft, and single function shaft are defined as L_{D1}, L_{D2}, L_{D3}, L_{D4}, and L_{S1}, respectively.

Specific to the three stage air shock of FIG. 22, the diameters and lengths of the working tube 23, first dual function shaft 24, second dual function shaft 25, and single function shaft 26 decrease in the order D_{W}>D_{D1}>D_{D2}>D_{S1}, and L_{W}>L_{W1}>L_{W2}>L_{W3}, respectively. This allows the first dual function shaft 24 to slidably insert into the working tube 23, the second dual function shaft 25 to slidably insert into the first dual function shaft 24, and the single function shaft 26 to slidably insert into the second dual function shaft 25.

Specific to the four stage air shock in FIG. 23, the diameters and lengths of the working tube 33, first dual function shaft 34, second dual function shaft 35, third dual function shaft 36, and single function shaft 37 decrease in the order D_{W}>D_{D1}>D_{D2}>D_{D3}>D_{S1} and L_{W}>L_{W1}>L_{W2}>L_{W3}>L_{W4}, respectively. This allows the first dual function shaft 34 to slidably insert into the working tube 33, the second dual function shaft 35 to slidably insert into the first dual function shaft 34, the third dual function shaft 36 to slidably insert into the second dual function shaft 35, and the single function shaft 37 to slidably insert into the third dual function shaft 36.

Specific to the five stage air shock in FIG. 24, the diameters and lengths of the working tube 46, first dual function shaft 47, second dual function shaft 48, third dual function shaft 49, fourth dual function shaft 50, and single function shaft 51 decrease in the order D_{W}>D_{D1}>D_{D2}>D_{D3}>D_{D4}>D_{S1} and L_{W}>L_{W1}>L_{W2}>L_{W3}>L_{W4}>L_{W5}, respectively. This allows the first dual function shaft 47 to slidably insert into the working tube 46, the second dual function shaft 48 to slidably insert into the first dual function shaft 47, the third dual function shaft 49 to slidably insert into the second dual function shaft 48, the fourth dual function shaft 50 to slidably insert into the third dual function shaft 49, and the single function shaft 51 to slidably insert into the fourth dual function shaft 50.

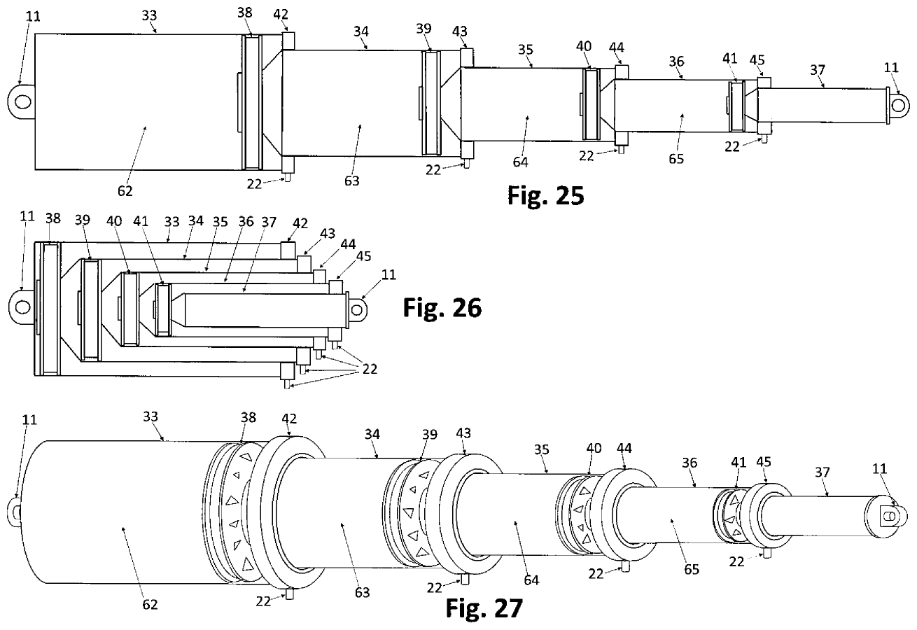

Referring to FIGS. 25 and 27, the multiple stage air shock comprising four stages is illustrated, thereby defining a four stage air shock.

The first stage refers to the working tube 33 and first dual function shaft 34. The working tube 33 has a closed end affixed to a mounting eyelet 11, and an open end attached to a first end cap 42. The first dual function shaft 34 has a closed end and an open end. The closed end of the first dual function shaft 34 is narrowed down thereby defining a first shaft shoulder and threaded shank. The threaded shank is attached to a first working piston 38, while the open end is attached to a second end cap 43. The closed end of the first dual function shaft 34 is slidably inserted through the first end cap 42 and into the open end of the working tube 33, thus allowing the first dual function shaft 34 to slide in and out of the working tube 33 under cooperative guidance by the first working piston 38 and first end cap 42. The act of the first dual function shaft 34 being inserted into the working tube 33 defines a space 62 within the working tube 33 that is between the closed end of the working tube 33 and first end cap 42. The space 62 has a volume V_{W} and refers to the volume V_{W} of the first stage. The first end cap 42 is equipped with a check valve 22, which serves as a means to add oil and gas to, or remove oil and gas from the first stage such that the space 62 is occupied by the oil and gas. The first end cap 42 acts as a seal to confine the oil and gas within the space 62, and allows the oil to have a volume, and gas to have both a volume and a pressure.

The second stage refers to the first dual function shaft 34 and second dual function shaft 35. The second dual function shaft 35 has both a closed end and an open end. The closed end is narrowed down to define a second shaft shoulder and threaded shank, wherein the threaded shank is attached to a second working piston 39 while the open end is attached to a third end cap 44. The closed end of the second dual function shaft 35 is slidably inserted through the second end cap 43 and into the open end of the first dual function shaft 34. This allows the second dual function shaft 35 to slide in and out of the first dual function shaft 34 under cooperative guidance by the second working piston 39 and second end cap 43. The act of the second dual function shaft 35 being inserted into the first dual function shaft 34 defines a space 63 within the first dual function shaft 34 between the closed end of the first dual function shaft 34 and second end cap 43. The space 63 has a volume V_{W1} and refers to the volume V_{W1} of the second stage. The second end cap 43 is equipped with a check valve 22, the check valve 22 serves as a means to add oil and gas to, or remove oil and gas from the second stage such that the space 63 is occupied by the oil and gas. Additionally, the second end cap 43 acts as a seal such that the oil and gas are confined to the space 63, and the confinement allows the oil to have a volume, and gas to have both a volume and pressure.

The third stage refers to the second dual function shaft 35 and third dual function shaft 36. The third dual function shaft 36 has a closed end and an open end. The closed end is narrowed down thereby defining a third shaft shoulder and threaded shank, wherein the threaded shank is attached to a third working piston 40 while the open end is attached to a fourth end cap 45. The closed end of the third dual function shaft 36 is slidably inserted through the third end cap 44 and into the open end of the second dual function shaft 35, allowing the third dual function shaft 36 to slide in and out of the second dual function shaft 35 under cooperative guidance by the third working piston 40 and third end cap 44. The act of the third dual function shaft 36 being inserted into the second dual function shaft 35 defines a space 64 within the second dual function shaft 35 between the closed end of the second dual function shaft 35 and third end cap 44. The space 64 has a volume V_{W2} and refers to the volume V_{W2} of the third stage. The third end cap 44 is equipped with a check valve 22, the check valve 22 serves as a means to add oil and gas to, or remove oil and gas from the third stage such that the space 64 is occupied by the oil and gas. The third end cap 44 acts as a seal such that the oil and gas are confined to the space 64, and the confinement allows the oil to have a volume and gas to have both a volume and pressure.

The fourth stage refers to the third dual function shaft 36 and single function shaft 37. The single function shaft 37 has a first and second closed ends. The first closed end is narrowed down thereby defining a fourth shaft shoulder and threaded shank, wherein the threaded shank is attached to a fourth working piston 41 while the second closed end is affixed to a mounting eyelet 11. The first closed end of the single function shaft 37 is slidably inserted through the fourth end cap 45 and into the open end of the third dual function shaft 36, allowing the single function shaft 37 to slide in and out of the third dual function shaft 36 under cooperative guidance by the fourth working piston 41 and fourth end cap 45. The act of the single function shaft 37 being inserted into the third dual function shaft 36 defines a space 65 within the third dual function shaft 36 between the closed end of the third dual function shaft 36 and fourth end cap 45. The space 65 has a volume V_{W3} and refers to the volume V_{W3} of the fourth stage. The fourth end cap 45 is equipped with a check valve 22, the check valve 22 serves as a means to add oil and gas to or remove oil and gas from the fourth stage such that the space 65 is occupied by the oil and gas. Whereby the fourth end cap 45 acts as a seal so that the oil and gas are confined to the space 65, and the confinement allows the oil to have a volume and gas to have both a volume and pressure.

The first, second, third, or fourth stage is charged with both sufficient oil and gas. Sufficient oil ensures that the first working piston 38, second working piston 39, third working piston 40, or fourth working piston 41 is submerged in oil as the first dual function shaft 34, second dual function shaft 35, third dual function shaft 36, or single function shaft 37 slides fully into or out of the working tube 33, first dual function shaft 34, second dual function shaft 35, or third dual function shaft 36. Sufficient gas ensures that the gas pressure in the first, second, third, or fourth stage supports one-fourth of the weight of the vehicle (one-fourth based on four air shocks per vehicle). The combination of the first dual function shaft 34 sliding in and out of the working tube 33, the second dual function shaft 35 sliding in and out of the first dual function shaft 34, the third dual function shaft 36 sliding in and out of the second dual function shaft 35, and the single function shaft 37 sliding in and out of the third dual function shaft 36 refers to the first, second, third, and fourth stages being interconnected in series, respectively. The sliding actions of the first dual function shaft 34, second dual function shaft 35, third dual function shaft 36, and single function shaft 37 are independent of one another such that the first, second, third, and fourth stages operate independently of one another.

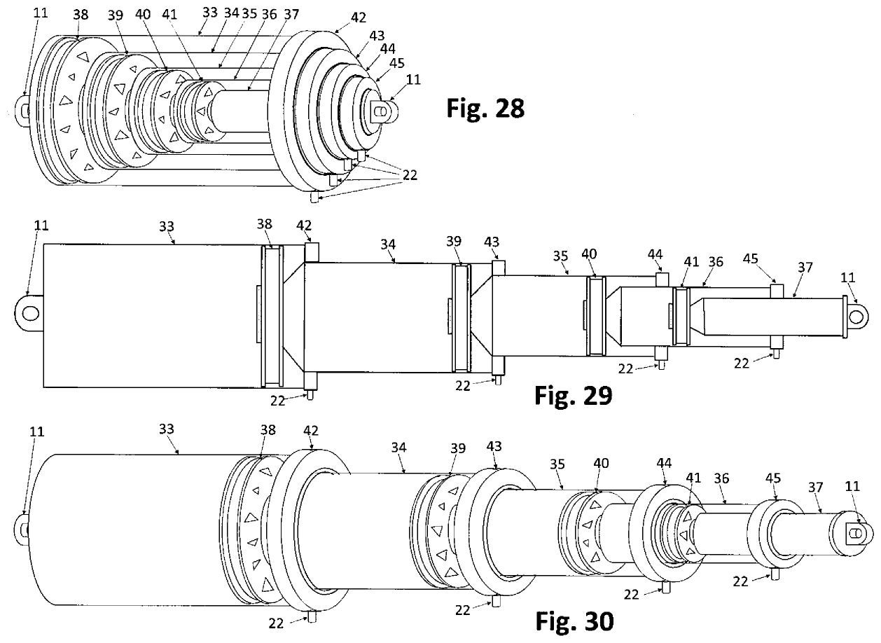

Referring now to FIGS. 25-30, each stage in the four stage air shock is illustrated in various states of operation, whereby the operation refers to extension and compression. Specific to FIGS. 25 and 27, the first, second, third, and fourth stages are all fully extended; while in FIGS. 26 and 28, the first, second, third, and fourth stages are all fully compressed. Specific to FIGS. 29 and 30, the first and second stages are fully extended while the third stage is compressed to 70% of shaft stroke and fourth stage is compressed to 40% of shaft stroke.

Regarding operation of the first stage, during compression the first dual function shaft 34 slides into the working tube 33, which pushes the first working piston 38 through the oil and also decreases the volume of the first stage. The decrease in volume acts to increase the gas pressure. During extension the first dual function shaft 34 slides out of the working tube 33, which both pulls the first working piston 38 through the oil and increases the volume of the first stage. The increase in volume results in a decrease of the gas pressure. The length of the first dual function shaft 34 from full extension to full compression or vice versa refers to the first dual function shaft stroke L_{D1} or shaft stroke of the first stage L_{D1}. The pressure of the gas is related to the gas charge and provides the first stage with a suspension spring capability, thereby enabling the first stage both to support part of the weight of the vehicle and to react to suspension movements. The suspension movements are what cause the first stage to either compress or extend, whereby the suspension spring capability of the first stage defines the operation of the first stage. Any partial compression or extension of the first stage refers to part of the suspension spring capability being utilized in the operation of the first stage.

The part of the suspension spring capability that is utilized in the operation of the first stage is dependent on the gas charge. The movement of the first working piston 38 through the oil is what dampens the suspension spring movement of the first stage The suspension spring movement of the first stage is caused by the change in pressure of the gas in the first stage, while the change in pressure of the gas in the first stage is caused by the change in volume of the first stage. The change in volume of the first stage is caused by the first dual function shaft 34 sliding in or out of the working tube 33. The motion by the first dual function shaft 34 is caused by suspension forces exerted on the first stage, and also results in a mixing of the oil and gas occupying the first stage.

Regarding operation of the second stage, during compression the second dual function shaft 35 slides into the first dual function shaft 34 thereby both pushing the second working piston 39 through the oil and decreasing the volume of the second stage. The decrease in volume acts to increase the gas pressure during compression. While during extension, the second dual function shaft 35 slides out of the first dual function shaft 34, thereby both pulling the second working piston 39 through the oil and increasing the volume of the second stage. The increase in volume results in a decrease in the gas pressure. The length of the second dual function shaft 35 from full extension to full compression or vice versa refers to the second dual role shaft stroke L_{D2} or shaft stroke of the second stage L_{D2}. The pressure of the gas is related to the gas charge and is what provides the second stage with a suspension spring capability. The suspension spring capability is what allows the second stage to both support part of the weight of the vehicle and to react to suspension movements. The suspension movements causes the second stage to undergo an operation of compression or extension, whereby the suspension spring capability of the second stage defines the operation of the second stage such that partial compression or extension of the second stage refers to part of the suspension spring capability being utilized in the operation of the second stage.

The part of the suspension spring capability that is utilized in the operation of the second stage is dependent on the gas charge. The movement of the second working piston 39 through the oil dampens the suspension spring movement of the second stage. The suspension spring movement of the second stage is caused by the change in pressure of the gas in the second stage, while the change in pressure of the gas in the second stage is caused by the change in volume of the second stage. The change in volume of the second stage is caused by the second dual function shaft 35 sliding in or out of the first dual function shaft 34. The motion of the second dual function shaft 35 is caused by suspension forces exerted on the second stage, and also results in a mixing of the oil and gas occupying the second stage.

Regarding operation of the third stage, during compression the third dual function shaft 36 slides into the second dual function shaft 35, thereby both pushing the third working piston 40 through the oil and decreasing the volume of the third stage. The decrease in volume causes an increase to the gas pressure. While during extension the third dual function shaft 36 slides out of the second dual function shaft 35, thereby both pulling the third working piston 40 through the oil and increasing the volume of the third stage. The increase in volume causes a decrease to the gas pressure. The length of the third dual function shaft 36 from full extension to full compression or vice versa refers to the third dual function shaft stroke L_{D3} or shaft stroke of the third stage L_{D3}. The pressure of the gas is related to the gas charge and provides the third stage with a suspension spring capability, which allows the third stage to both support part of the weight of the vehicle, and to react to suspension movements. The suspension movements cause the third stage to undergo an operation of compression or extension, whereby the suspension spring capability of the third stage defines the operation of the third stage such that partial compression or extension of the third stage refers to part of the suspension spring capability being utilized in the operation of the third stage.

The part of the suspension spring capability that is utilized in the operation of the third stage is dependent on the gas charge. The movement of the third working piston 40 through the oil dampens the suspension spring movement of the third stage. The suspension spring movement of the third stage is caused by the change in pressure of the gas in the third stage, while the change in pressure of the gas in the third stage is caused by the change in volume of the third stage. The change in volume of the third stage is caused by the third dual function shaft 36 sliding in or out of the second dual function shaft 35. The motion of the third dual function shaft 36 is caused by suspension forces exerted on the third stage, and also results in a mixing of the oil and gas occupying the third stage.

Regarding operation of the fourth stage, during compression the single function shaft 37 slides into the third dual function shaft 36, thereby both pushing the fourth working piston 41 through the oil, and also decreasing the volume of the fourth stage. The decrease in volume causes an increase in the gas pressure. While during extension, the single function shaft 37 slides out of the third dual function shaft 36, thereby both pulling the fourth working piston 41 through the oil, and also increasing the volume of the fourth stage. The increase in volume causes a decrease in the gas pressure. The length of the single function shaft 37 from full extension to full compression or vice versa refers to the single function shaft stroke L_{S1} or shaft stroke of the fourth stage L_{S1}. The pressure of the gas is related to the gas charge, and provides the fourth stage with a suspension spring capability. This is what allows the fourth stage both to support part of the weight of the vehicle and to react to suspension movements. The suspension movements cause the fourth stage to undergo an operation of either compression or extension, whereby the suspension spring capability of the fourth stage defines the operation of the fourth stage such that partial compression or extension of the fourth stage refers to part of the suspension spring capability being utilized in the operation of the fourth stage.

The part of the suspension spring capability that is utilized in the operation of the fourth stage is dependent on the gas charge. The movement of the fourth working piston 41 through the oil dampens the suspension spring movement of the fourth stage. The suspension spring movement of the fourth stage is caused by the change in pressure of the gas in the fourth stage, while the change in pressure of the gas in the fourth stage is caused by the change in volume of the fourth stage. The change in volume of the fourth stage is caused by the single function shaft 37 sliding in or out of the third dual function shaft 36. The motion of the single function shaft 37 is caused by suspension forces exerted on the fourth stage, and also results in a mixing of the oil and gas occupying the fourth stage.

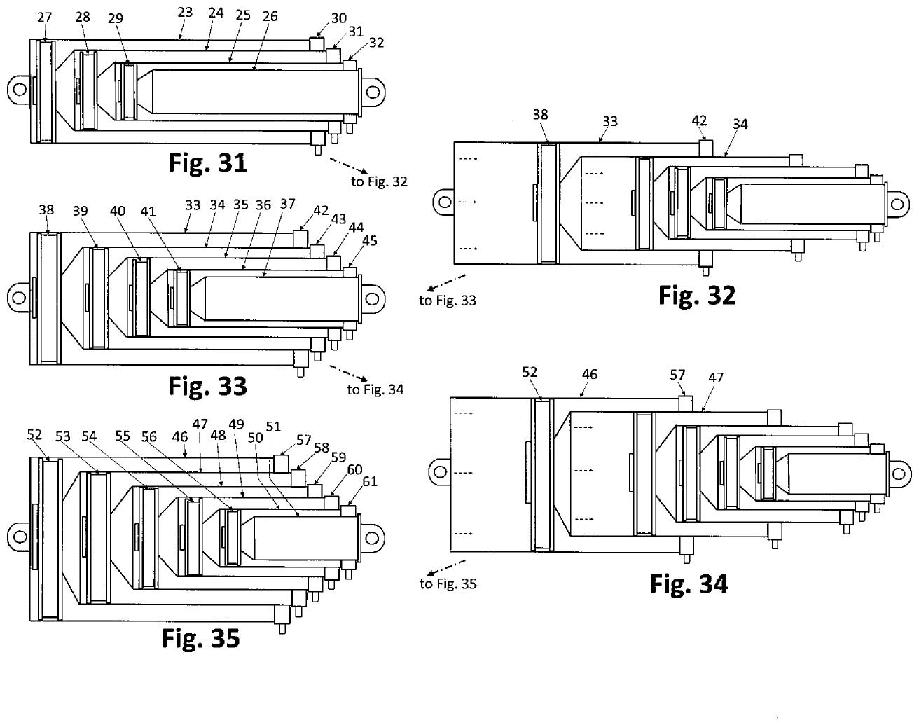

Referring now to FIGS. 31-35, there is shown a method for adding a stage to the three or four stage air shock.

In principle, a stage can be added to the multiple stage air shock in two different ways. The first way refers to adding a stage onto the working tube end of the multiple stage air shock, while the second way refers to adding a stage onto the single function shaft end of the multiple stage air shock. In the first way, a new working tube is added while the existing working tube is removed and replaced with a new dual function shaft, whereby the new dual function shaft is attached to a new working piston. The new working tube is attached to a new end cap such that the new dual function shaft is slidably inserted through the new end cap and into the new working tube. The new working tube and dual function shaft define the stage that is added to the multiple stage air shock. In the second way, the existing single function shaft is removed and replaced with a new dual function shaft, whereby the new dual function shaft is attached to a new end cap. A new single function shaft is slidably inserted through the new end cap and into the new dual function shaft. The new single and dual function shafts define the stage that is added to the multiple stage air shock. In the first way in order for the new dual function shaft to be inserted into the new working tube, the diameter of the new working tube must be greater than is that of the existing working tube. While in the second way in order for the new single function shaft to be inserted into the new dual function shaft, the diameter of the new single function shaft must be smaller than is that of the existing single function shaft. In the second way as new stages are added, the diameter of the new single function shaft will become so small that the new single function shaft will not be able to serve as a shaft in the multiple stage air shock. Therefore, as a practical matter, the multiple stage air shock is able to be constructed with the first way only by adding a stage onto the working tube end of the multiple stage air shock. This way, the additional stage becomes the first stage for the multiple stage air shock. The existing stages and their parts are also changed in order to accommodate the addition of the new first stage. The new working tube becomes the working tube, the existing working tube is removed and replaced with a new first dual function shaft. The new first dual function shaft, new first working piston, shaft shoulder, and end cap become the first dual function shaft, working piston, shaft shoulder, and end cap. Whereas, the existing first dual function shaft, working piston, shaft shoulder, and end cap become the second dual function shaft, working piston, shaft shoulder, and end cap. This change in part names can happen until the nth end cap that is attached to the existing n−1th dual function shaft becomes the n+1th end cap, while the nth working piston and shaft shoulder that are attached to the single function shaft become the n+1th working piston and shaft shoulder (n+1 refers to the new number of stages in the multiple stage air shock).

Referring now to FIGS. 31-33, the four stage air shock can be constructed by adding a new first stage to the three stage air shock. The three stage air shock is made up of an existing working tube 23, and existing first dual function shaft 24, working piston 27, shaft shoulder, and end cap 30; existing second dual function shaft 25, working piston 28, shaft shoulder, and end cap 31; and, existing single function shaft 26, and existing third working piston 29, shaft shoulder, and end cap 32. The four stage air shock comprises a working tube 33, and first dual function shaft 34, working piston 38, shaft shoulder, and end cap 42; second dual function shaft 35, working piston 39, shaft shoulder, and end cap 43; third dual function shaft 36, working piston 40, shaft shoulder, and end cap 44; and, single function shaft 37, and fourth working piston 41, shaft shoulder, and end cap 45. The new first stage refers to the new working tube, and new first dual function shaft, working piston, shaft shoulder, and end cap which in turn refer to the working tube 33, and first dual function shaft 34, working piston 38, shaft shoulder, and end cap 42 of the four stage air shock, respectively.

Referring specifically to FIG. 32, the three stage air shock is transformed into the four stage air shock by adding the new working tube, new first working piston, shaft shoulder, and end cap to the three stage air shock, while the existing working tube 23 is removed and replaced with the new first dual function shaft in the three stage air shock. The transformation involves the following steps: (1a) the new first dual function shaft slides into and out of the new working tube and (1b) the new working tube, and new first dual function shaft, working piston, shaft shoulder, and end cap are specified as the working tube 33, and first dual function shaft 34, working piston 38, shaft shoulder, and end cap 42 whereby a cooperation between (1a) and (1b) enables the first dual function shaft 34 to slide into and out of the working tube 33 thereby defining the first stage in the four stage air shock; (2a) the existing first dual function shaft 24 slides into and out of the new first dual function shaft, (2b) the existing first dual function shaft 24, working piston 27, shaft shoulder, and end cap 30 are specified as the second dual function shaft 35, working piston 39, shaft shoulder, and end cap 43, and (2c) the new first dual function shaft, working piston, shaft shoulder, and end cap are specified as the first dual function shaft 34, working piston 38, shaft shoulder, and end cap 42 whereby a cooperation among (2a), (2b), and (2c) enables the second dual function shaft 35 to slide into and out of the first dual function shaft 34 thereby defining the second stage in the four stage air shock; (3a) the existing second dual function shaft 25 slides into and out of the existing first dual function shaft 24, (3b) the existing second dual function shaft 25, working piston 28, shaft shoulder, and end cap 31 are specified as the third dual function shaft 36, working piston 40, shaft shoulder, and end cap 44, and (3c) the existing first dual function shaft 24, working piston 27, shaft shoulder, and end cap 30 are specified as the second dual function shaft 35, working piston 39, shaft shoulder, and end cap 43 whereby a cooperation among (3a), (3b), and (3c) enables the third dual function shaft 36 to slide into and out of the second dual function shaft 35 thereby defining the third stage in the four stage air shock; and (4a) the existing single function shaft 26 slides into and out of the existing second dual function shaft 25, (4b) the existing single function shaft 26, and existing third working piston 29, shaft shoulder, and end cap 32 are specified as the single function shaft 37, and fourth working piston 41, shaft shoulder, and end cap 45, and (4c) the existing second dual function shaft 25, working piston 28, shaft shoulder, and end cap 31 are specified as the third dual function shaft 36, working piston 40, shaft shoulder, and end cap 44 whereby a cooperation among (4a), (4b), and (4c) enables the single function shaft 37 to slide into and out of the third dual function shaft 36 thereby defining the fourth stage in the four stage air shock.

Referring now to FIGS. 33-35, the five stage air shock can be constructed by adding a new first stage to the four stage air shock. The four stage air shock is made up of an existing working tube 33, existing first dual function shaft 34, working piston 38, shaft shoulder, and end cap 42; existing second dual function shaft 35, working piston 39, shaft shoulder, and end cap 43; existing third dual function shaft 36, working piston 40, shaft shoulder, and end cap 44; and, existing single function shaft 37, existing fourth working piston 41, shaft shoulder, and end cap 45. The five stage air shock comprises a working tube 46, first dual function shaft 47, working piston 52, shaft shoulder, and end cap 57; second dual function shaft 48, working piston 53, shaft shoulder, and end cap 58; third dual function shaft 49, working piston 54, shaft shoulder, and end cap 59; fourth dual function shaft 50, working piston 55, shaft shoulder, and end cap 60; and, single function shaft 51, fifth working piston 56, shaft shoulder, and end cap 61. The new first stage refers to the new working tube, new first dual function shaft, working piston, shaft shoulder, and end cap; which in turn refers to the working tube 46, and first dual function shaft 47, working piston 52, shaft shoulder, and end cap 57 of the five stage air shock, respectively.

Referring specifically to FIG. 34, the four stage air shock is transformed into the five stage air shock by adding the new working tube, new first working piston, shaft shoulder, and end cap to the four stage air shock, while the existing working tube 33 is removed and replaced with the new first dual function shaft in the four stage air shock. The transformation involves the following steps. First, (1a) the new first dual function shaft slides into and out of the new working tube and (1b) the new working tube, and new first dual function shaft, working piston, shaft shoulder, and end cap are specified as the working tube 46, and first dual function shaft 47, working piston 52, shaft shoulder, and end cap 57 whereby a cooperation between (1a) and (1b) enables the first dual function shaft 47 to slide in and out of the working tube 46, thereby forming the first stage in the five stage air shock. Second, (2a) the existing first dual function shaft 34 slides into and out of the new first dual function shaft, (2b) the existing first dual function shaft 34, working piston 38, shaft shoulder, and end cap 42 are specified as the second dual function shaft 48, working piston 53, shaft shoulder, and end cap 58, and (2c) the new first dual function shaft, working piston, shaft shoulder, and end cap are specified as the first dual function shaft 47, working piston 52, shaft shoulder, and end cap 57. Whereby a cooperation among (2a), (2b), and (2c) allows the second dual function shaft 48 to slide in and out of the first dual function shaft 47 thereby defining the second stage in the five stage air shock. Third, (3a) the existing second dual function shaft 35 slides in and out of the existing first dual function shaft 34, (3b) the existing second dual function shaft 35, working piston 39, shaft shoulder, and end cap 43 are specified as the third dual function shaft 49, working piston 54, shaft shoulder, and end cap 59, and (3c) the existing first dual function shaft 34, working piston 38, shaft shoulder, and end cap 42 are specified as the second dual function shaft 48, working piston 53, shaft shoulder, and end cap 58. Whereby a cooperation among (3a), (3b), and (3c) enables the third dual function shaft 49 to slide in and out of the second dual function shaft 48 thereby defining the third stage in the five stage air shock. Fourth, (4a) the existing third dual function shaft 36 slides into and out of the existing second dual function shaft 35, (4b) the existing third dual function shaft 36, working piston 40, shaft shoulder, and end cap 44 are specified as the fourth dual function shaft 50, working piston 55, shaft shoulder, and end cap 60, and (4c) the existing second dual function shaft 35, working piston 39, shaft shoulder, and end cap 43 are specified as the third dual function shaft 49, working piston 54, shaft shoulder, and end cap 59. Whereby a cooperation among (4a), (4b), and (4c) enables the fourth dual function shaft 50 to slide into and out of the third dual function shaft 49 thereby defining the fourth stage in the five stage air shock. Finally, (5a) the existing single function shaft 37 slides into and out of the existing third dual function shaft 36, (5b) the existing single function shaft 37, and existing fourth working piston 41, shaft shoulder, and end cap 45 are specified as the single function shaft 51, and fifth working piston 56, shaft shoulder, and end cap 61, and (5c) the existing third dual function shaft 36, working piston 40, shaft shoulder, and end cap 44 are specified as the fourth dual function shaft 50, working piston 55, shaft shoulder, and end cap 60. Whereby a cooperation among (5a), (5b), and (5c) enables the single function shaft 51 to slide in and out of the fourth dual function shaft 50 thereby defining the fifth stage in the five stage air shock.

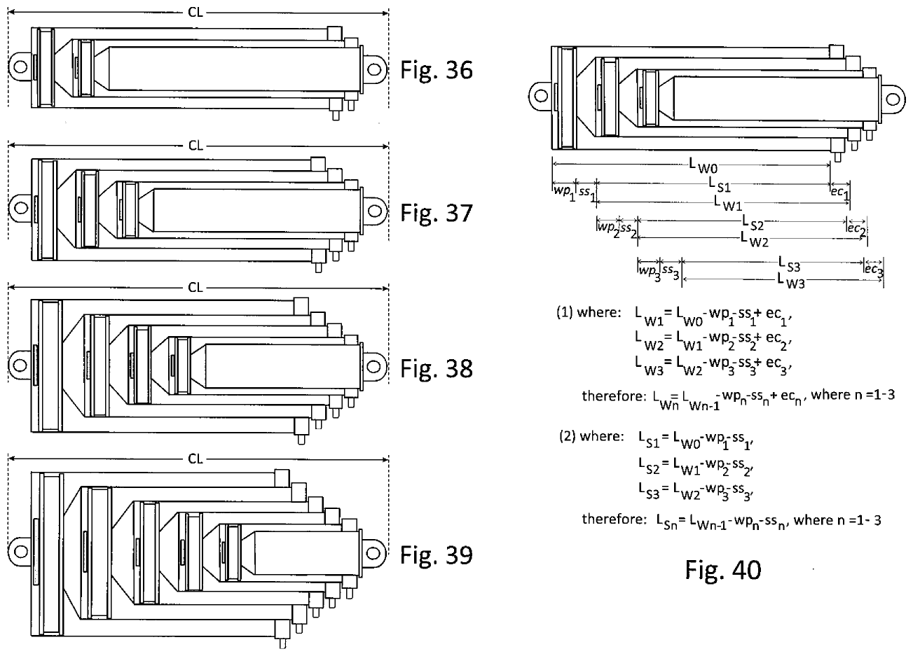

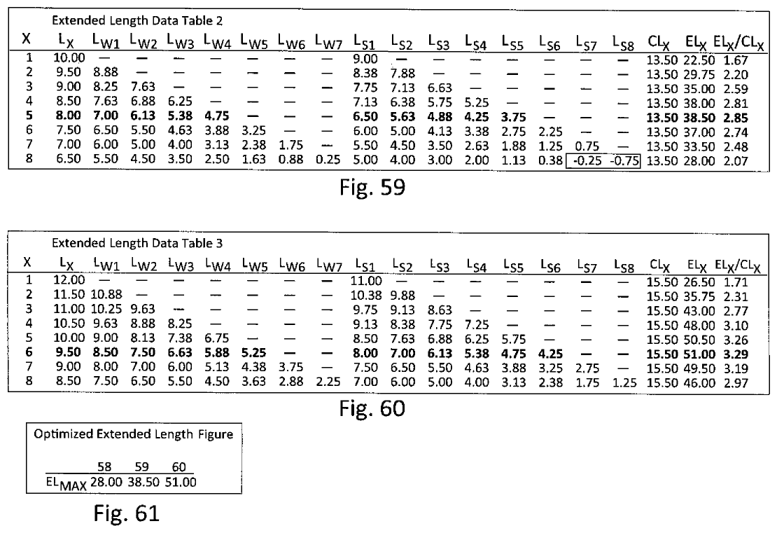

Referring now to FIGS. 36-61, there is shown a first methodology for determining the compressed and extended lengths of the four stage air shock. In this case, emphasizing the capability of the first methodology to provide an air shock with an extended length that is greater than twice its compressed length. The dimensions derived from the first methodology are utilized in a second methodology, discussed below, which describes how to estimate a relatively linear spring rate for the four stage air shock.

Any shock absorber must have a compressed length that accommodates the “bottomed out” condition of a vehicle's suspension system. Given that the “bottomed out” condition of a vehicle's suspension system is constant/never changes, the compressed length must also be the same for any shock absorber installed on the vehicle. Therefore, for a particular multiple stage air shock, the compressed length is constant regardless of the number of stages. FIGS. 36-40 show the two, three, four, and five stage air shocks, respectively, and highlights two prominent features; each air shock has the same compressed length, and the lengths of the components for a given stage decrease while viewing sequentially from the two, three, four, and then five stage air shock, the components referring to one and the second components. In order to maintain a constant compressed length, the lengths of the components comprising each stage must be decreased as the number of stages making up the multiple stage air shock increases. Specific to FIG. 40, a method to determine the lengths of the components in a three stage air shock to serve as the basis for creating the first methodology is shown. The first methodology includes a set of equations that are used for computing various dimensions of each stage, whereby the dimensions include the lengths of the working tube and each dual function shaft, the shaft stroke of each dual function shaft, and single function shaft; thereby making up the shaft stroke of each stage. The first methodology is flexible and can be applied to the construction of the multiple stage air shock with any given number of stages. Although the construction of the multiple stage air shock is defined in terms of both the diameter and length of each component comprising the stage, the diameter is not discussed herein because it does not require computation. Instead, values for the diameters of the first and the other interconnected components are selected with the knowledge that the diameter of the first component must be less than that of the second component, so that that the first component is able to slide in and out of the second component.

Application of the first methodology is exemplified in the tables shown in FIGS. 58-60. Each table was developed for a particular multiple stage air shock and includes eight rows of data. Each row represents the multiple stage air shock with a different number of stages such that each table represents eight different multiple stage air shocks, each with a given number of stages and the same compressed length. Whereby particular refers to different numbers of stages but the same compressed length. When viewing the eight rows in a table in descending order, the eight rows represent the data for the multiple stage air shock with an increasing number of stages, i.e., after a new first stage has been added to the multiple stage air shock. As a matter of principle, the multiple stage air shock must be made up of at least one first stage. When one first stage is the only stage in the multiple stage air shock, the one first stage represents one stage, thereby defining the multiple stage air shock as a single stage air shock. This single stage air shock is similar to an ordinary air shock that is well known in the art.

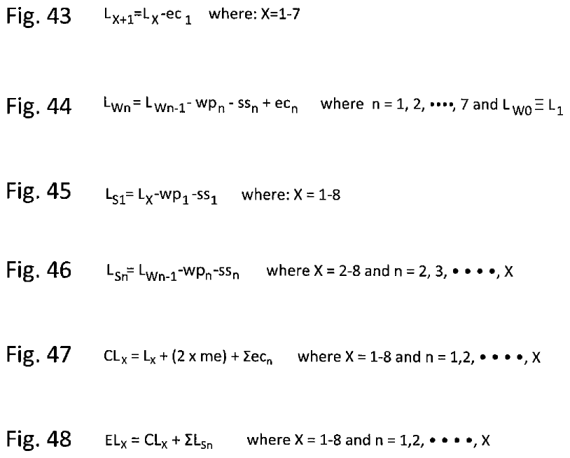

The first methodology is designed to compute various linear dimensions for each stage when a new first stage is added to the multiple stage air shock. This application requires the use of the equations shown in FIGS. 43-48 and is exemplified by the eight rows of data for each table shown in FIGS. 58-60. However, the first methodology can be applied to compute various linear dimensions for each stage when a new first stage is not added to the multiple stage air shock. This application requires the use of the equations shown in FIGS. 44-48, ignoring the equation shown in FIG. 43, and is exemplified by any given row of data for each table shown in FIGS. 58-60.

For purposes of discussion, for any multiple stage air shock the length of the working tube for the one first stage is specified with the symbol, L₁. When new first stages are added to the multiple stage air shock, the addition of the new first stage defines the addition of the second, third, fourth, . . . eighth first stage, and the length of the working tube for the second, third, fourth, . . . eighth first stage is specified with the symbol, L₂, L₃, L₄, . . . L₈, respectively. When a new first stage is not added to the multiple stage air shock, the multiple stage air shock comprises a given number of stages, the one first stage defines the first stage, the length of the working tube for the first stage defines the length of the working tube, and the length of the working tube is specified with the symbol, L₁.

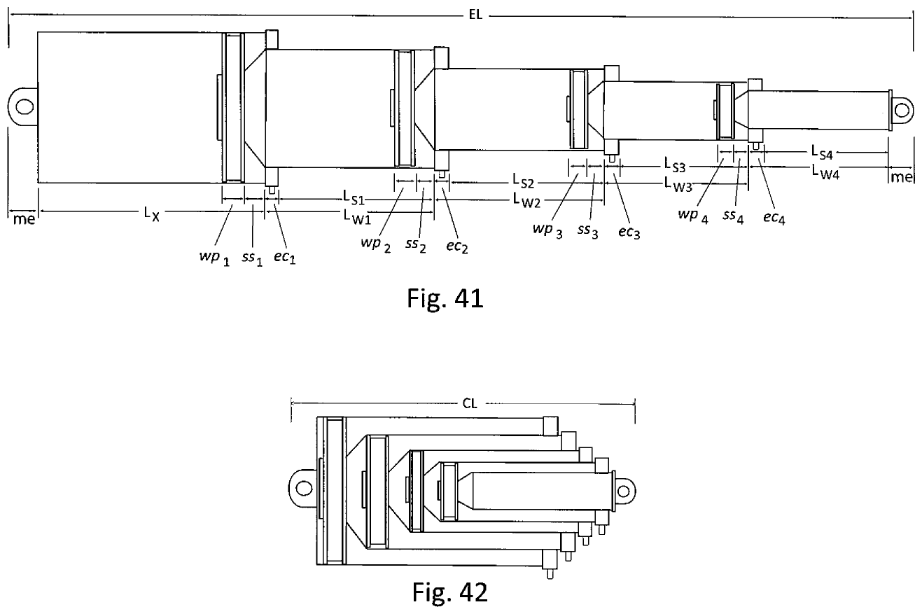

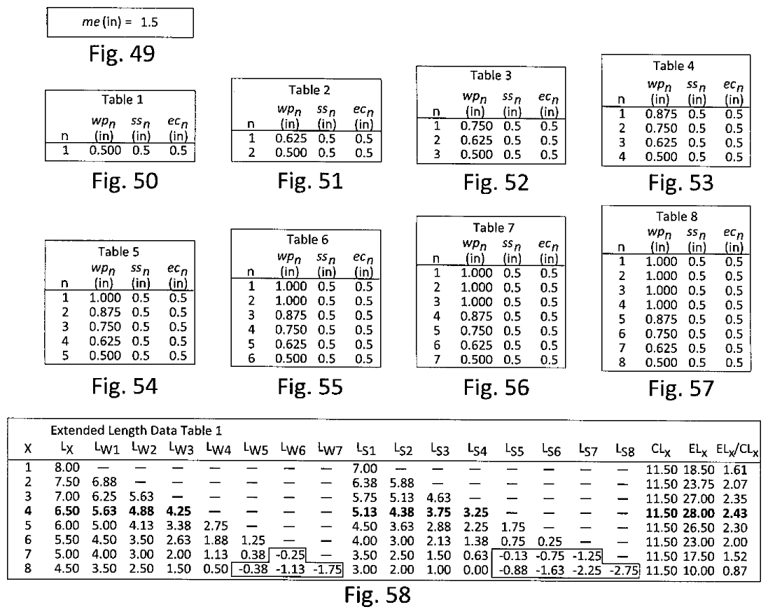

The first methodology involves the following five steps. First, referring to FIGS. 41 and 42, the following dimensions of the four stage air shock are defined: extended length, EL; compressed length, CL; lengths of the working tube and first, second, and third dual function shafts and single function shaft, L_{X} and L_{W1-4}; shaft strokes of the first, second, third, and fourth stages, L_{S1-4}; and thicknesses of the first, second, third, and fourth working pistons, wp₁₋₄; shaft shoulders, ss₁₋₄; and end caps, ec₁₋₄. These dimensions serve as the basis for the dimensions shown in FIGS. 43-61. A value is selected for the thickness of the mounting eyelet, me, whereby this value is shown in FIG. 49; and a value is selected for the length of working tube, L₁, whereby this value is shown in FIGS. 58-60 and a different value for L₁ is selected for each figure. The length of the working tube is able to be interpreted in two different ways, depending on the application of the first methodology. The first way is if the first methodology is applied to determine the length of the working tube for each first stage when a new first stage is added to the multiple stage air shock. If this happens then a value for the length of the working tube for the one first stage, L₁, is selected, while a value for the length of the working tube for each additional first stage, L₂₋₈, is computed with the equation shown in FIG. 43. The second way the first methodology is used to determine the length of the working tube for the one first stage is when a new first stage is not added to the multiple stage air shock. If this happens then the multiple stage air shock is made up of a given number of stages, the one first stage defines the first stage, a value for the length of the working tube, L₁, is selected, and the equation shown in FIG. 43 is ignored.

In the second step, the values are selected for the thicknesses of the working piston, wpₙ, shaft shoulder, ssₙ, and end cap, ecₙ, for the nth or n+1th stage, whereby these values are shown in FIGS. 50-57. Each FIG. 50-57 refers to n number of stages such that a new first stage is added when reading step-wise from one figure to the next figure. A new set of values are selected for wpₙ, ssₙ, and ecₙ for the new first stage. This way, the values for wpₙ, ssₙ, and ecₙ for the nth stage in FIG. 50 are applied to the n+1th stage in FIG. 51 and so on where n or n+1=1, 2, . . . , 8.

In the third step, the selected values are used in the equations shown in FIGS. 43-48 to compute the values for the: length of the working tube, L₂₋₈; length of the first, second, third, fourth, fifth, sixth, or seventh dual function shaft, L_{W1-7}; shaft strokes of the first, second, third, fourth, fifth, sixth, seventh, or eighth stage, L_{S1-8}; compressed length, CL_{X}; extended length, EL_{X}; and ratio of extended length vs compressed length, EL_{X}/CL_{X}. These computed values are shown in FIGS. 58-60, whereby for each figure, each row of values refers to the air shock with X number of stages and X=1-8.

In the fourth step, the largest value computed for the extended length EL_{X} refers to the optimum extended length EL_{MAX} and is copied from FIGS. 58-60 to FIG. 61. While in the fifth step, each row of FIGS. 58-60 where X=4, refers to the four stage air shock whereby the value computed for EL₄ represents the extended length based on a given compressed length CL₄.

Application of the first methodology for the four stage air shock involves the following steps eight steps. The first step involves defining the four stage air shock as a multiple stage air shock with a given number of stages. It is important to define the one first stage as the first stage, specifying the length of the working tube with the symbol, L₁, and using the equations shown in FIGS. 44-48 to determine the compressed and extended lengths, while ignoring the equation shown in FIG. 43.

The second step involves selecting values for: (a) length of the working tube, L₁; (b) thicknesses of the first, second, third, and fourth working pistons, wp₁₋₄, shaft shoulders, ss₁₋₄, and end caps, ec₁₋₄; and (c) thickness of the mounting eyelet me.

The third state involves computing values for the lengths of the first, second, and third dual function shafts, L_{W1-3}, and single function shaft, L_{W4}.

The fourth step involves accounting for the thicknesses of the working piston, wp₁₋₄, shaft shoulder, ss₁₋₄, and end cap, ec₁₋₄. When computing the length of the first component: (a) the first dual function shaft 34, working piston 38, and shaft shoulder are located inside the working tube 33, while the first end cap 42 is located at the open end of the working tube 33 when the first dual function shaft 34 slides fully into the working tube 33; (b) the second dual function shaft 35, working piston 39, and shaft shoulder are located inside the first dual function shaft 34 while the second end cap 43 is located at the open end of the first dual function shaft 34 when the second dual function shaft 35 slides fully into the first dual function shaft 34; (c) the third dual function shaft 36, working piston 40, and shaft shoulder are located inside the second dual function shaft 35 while the third end cap 44 is located at the open end of the second dual function shaft 35 when the third dual function shaft 36 slides fully into the second dual function shaft 35; and (d) the single function shaft 37 and fourth working piston 41 and shaft shoulder are located inside the third dual function shaft 36 while the fourth end cap 45 is located at the open end of the third dual function shaft 36 when the single function shaft 37 slides fully into the third dual function shaft 36.

The fifth step involves computing the length of the first component in terms of the length of the second component. This is based on the locations of the: (a) first dual function shaft 34, working piston 38, shaft shoulder, and end cap 42 when the first dual function shaft 34 slides fully into the working tube 33 define the length of the first dual function shaft, L_{W1}, as the sum of the length of the working tube, L₁, less the thicknesses of the first working piston, wp₁, and shaft shoulder, ss₁, plus the thickness of the first end cap, ec₁; (b) second dual function shaft 35, working piston 39, shaft shoulder, and end cap 43 when the second dual function shaft 35 slides fully into the first dual function shaft 34 define the length of the second dual function shaft, L_{W2}, as the sum of the length of the first dual function shaft, L_{W1}, less the thicknesses of the second working piston, wp₂, and shaft shoulder, ss₂, plus the thickness of the second end cap, ec₂; (c) third dual function shaft 36, working piston 40, shaft shoulder, and end cap 44 when the third dual function shaft 36 slides fully into the second dual function shaft 35 define the length of the third dual function shaft, L_{W3}, as the sum of the length of the second dual function shaft, L_{W2}, less the thicknesses of the third working piston, wp₃, and shaft shoulder, ss₃, plus the thickness of the third end cap, ec₃; and (d) single function shaft 37 and the fourth working piston 41, shaft shoulder, and end cap 45 when the single function shaft 37 slides fully into the third dual function shaft 36 define the length of the single function shaft, L_{W4}, as the sum of the length of the third dual function shaft, L_{W3}, less the thicknesses of the fourth working piston, wp₄, and shaft shoulder, ss₄, plus the thickness of the fourth end cap, ec₄.

The sixth step involves computing the shaft stroke of each stage in terms of the length of the other component: the first, second, and third dual function shaft strokes, L_{S1-3}, are equal to the sums of the lengths of the first, second, and third dual function shafts, L_{W1-3}, less the thicknesses of the first, second, and third end cap, ec₁-3 while the single function shaft stroke, L_{S4}, is equal to the sum of the length of the single function shaft, L_{W4}, less the thickness of the fourth end cap, ec₄. The summations define the shaft stroke of the: (a) first stage, L_{S1}, as the sum of the length of the working tube, L₁, less the thicknesses of the first working piston, wp₁, and shaft shoulder, ss₁; (b) second stage, L_{S2}, as the sum of the length of the first dual function shaft, L_{W1}, less the thicknesses of the second working piston, wp₂, and shaft shoulder, ss₂; (c) third stage, L_{S3}, as the sum of the length of the second dual function shaft, L_{W2}, less the thicknesses of the third working piston, wp₃, and shaft shoulder, ss₃; and (d) fourth stage, L_{S4}, as the sum of the length of the third dual function shaft, L_{W3}, less the thicknesses of the fourth working piston, wp₄, and shaft shoulder, ss₄, respectively.

The seventh step involves computing the compressed length, CL₄, as the sum of the length of the working tube, L₁, plus the thicknesses of two mounting eyelets, 2·me, plus the sum of the thickness of each end cap, ec₁₋₄.

The eighth and final step involves computing the extended length, EL₄, as the sum of the compressed length, CL₄, plus the sum of the shaft stroke of each stage, L_{S1-4}. Conclusions of the application of the first methodology for the four stage air shock includes four different aspects of note. First, referring to FIGS. 58-60, the value for EL₄/CL₄ for the four stage air shock is 2.43, 2.81, and 3.10, respectively. These values highlight an important feature—the multiple stage design is capable of producing an air shock whose extended length EL_{X} is greater than twice its compressed length CL_{X}—a feature inherently unobtainable for any ordinary shock absorber in the art. Second, referring to FIGS. 58-60, as the number of stages comprising the multiple stage air shock increases from one to eight, the extended length EL_{X} reaches a maximum value and then decreases where X=1-8. This discovery indicates that the first methodology offers an optimum extended length EL_{MAX} for a multiple stage air shock with a given compressed length CL_{X} where X=1-8. Third, the number of stages required to reach the optimum extended length EL_{MAX} for a multiple stage air shock is related to the compressed length CL_{X} where X=1-8. Finally, the values for the shaft strokes for each stage can be used in the second methodology (discussed in detail below) to estimate the spring rate for the four stage air shock.

Note: when referring to FIGS. 49-57 and L₁ in FIGS. 58-60, the dimensions and values listed therein are selected for purposes of discussion only and are not meant to imply proper values for any stage in the multiple stage air shock.

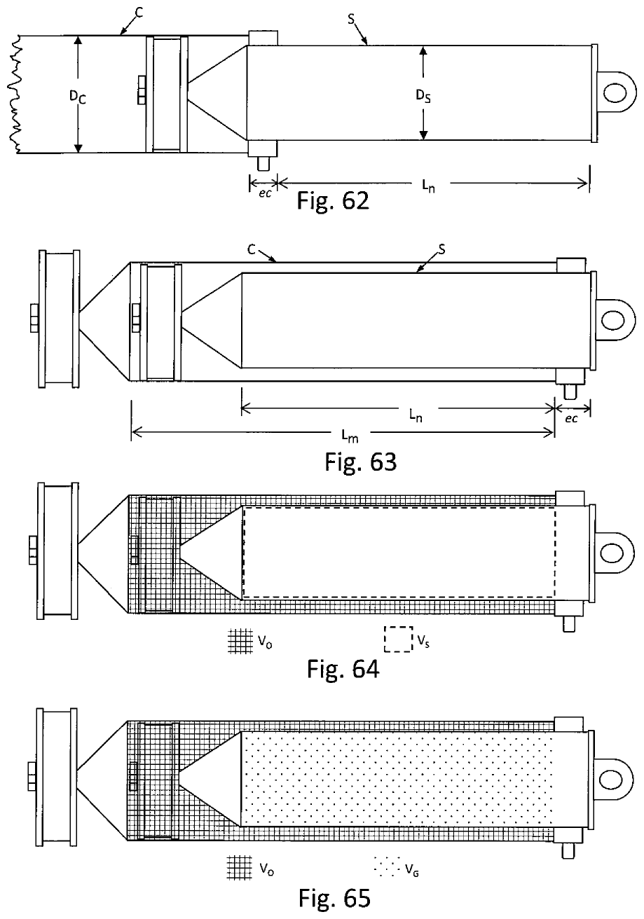

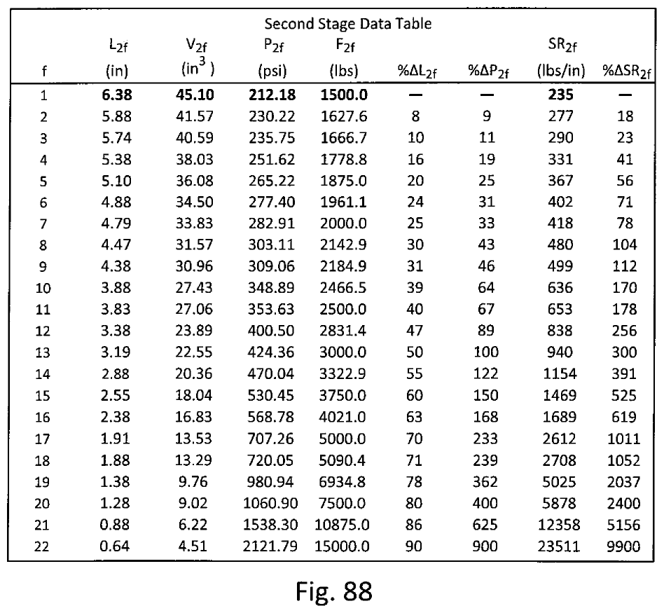

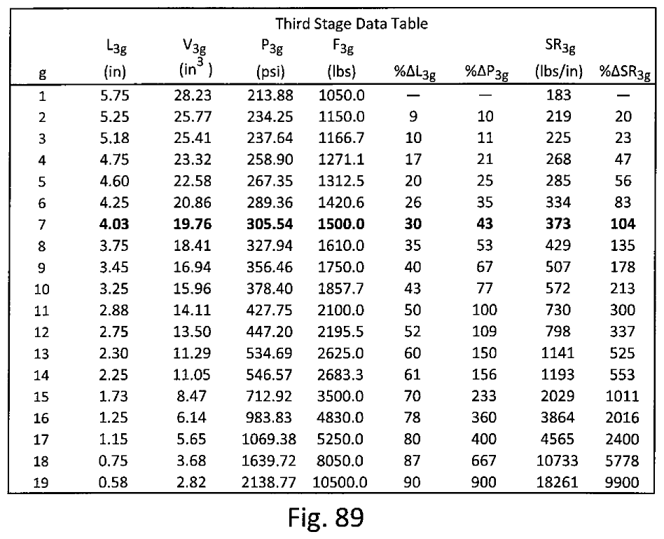

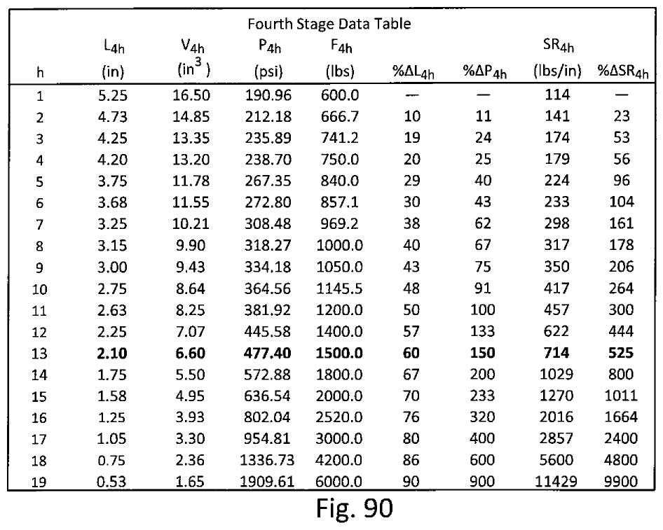

Referring now to FIGS. 62-99, the second methodology for estimating the spring rate for the four stage air shock is shown. These figures emphasize the capability of the second methodology to provide a relatively linear spring rate. The dimensions derived from the first methodology discussed above are utilized herein to derive a set-up for the four stage air shock. This set-up is a feature of the second methodology and serves to estimate the linearity of the spring rate.

The ordinary air shock has a progressive spring rate and provides little resistance for the first 60-75% of shock travel, and then gets exponentially harder for the final 30% of shock travel. Arguably, the air shock would serve as a better suspension spring if it possessed a linear spring rate similar to that for a steel spring. The spring rate for an air shock is well-known in the art and serves as the basis for creating the second methodology. The second methodology includes a set of equations that is used for computing various properties of each stage. The properties of each stage relate to the set-up for the four stage air shock and involve a graphical analysis of the operation for each stage. The second methodology is flexible and can be used to determine the spring rate for the multiple stage air shock with any given number of stages.

Referring to FIGS. 62-65, there is shown part of a stage that is fully extended and a stage that is fully compressed whereby for purposes of discussion: (1) the stage comprises the shaft S and component C, whereby the shaft S refers to the dual or single function shaft 16 or 15, while the component C refers to the working tube 10 or dual function shaft 16; (2) the shaft S has a diameter D_{S} and shaft stroke Lₙ while the component C has a diameter D_{C} and length Lₘ, and (3) the part of the working piston that is not saturated by the oil is ignored and the shaft shoulder is ignored, whereby the oil and gas occupy the space within the component C such that the volume of the space is the sum of the volumes of the oil and gas, V_{O} and V_{G}, respectively. Since the shaft stroke Lₙ defines how far the shaft S is able to slide in and out of the component C, the volume of the space within the component C that is occupied by the shaft S at full compression is defined by the volume of the shaft stroke V_{S}. Therefore, the volume of the shaft stroke V_{S} defines the volume of the gas V_{G} and the change in the volume of the shaft stroke defines the change in the volume of the gas.

The second methodology involves the following ten steps. First, the following properties are defined for each stage, whereby one or the second component of each stage is referred to as the component: (a) diameter of the component, D_{W}, D_{D1}, D_{D2}, D_{D3}, D_{S1}; (b) length of the component, L_{W}, L_{W1}, L_{W2}, L_{W3}; (c) shaft stroke of the component, L_{D1}, L_{D2}, L_{D3}, L_{S1}; (d) area of the component, A_{W}, A_{D1}, A_{D2}, A_{D3}, A_{S1}; (e) volume of the component, V_{W}, V_{W1}, V_{W2}, V_{W3}; (f) volume of the shaft stroke of the component, V_{D1}, V_{D2}, V_{D3}, V_{S1}; (g) volume of gas charge, V_{Gt}; (h) volume of oil charge, V_{Ot}; (i) suspension force at ride height, Fₜ; (j) shaft stroke at ride height, Lₜ; (k) volume at ride height, Vₜ; (l) gas charge at ride height, P_{Gt}; (m) percent of shaft stroke not compressed at ride height, % Lₜ; (n) Boyles' constant, cₜ; (o) incremental shaft stroke, L_{Z}; (p) gas volume, V_{Z}; (q) gas pressure, P_{Z}; (r) suspension force, F_{Z}; (s) spring rate, SR_{Z}; (t) percent change in incremental shaft stroke, % ΔL_{Z}; (u) percent change in gas pressure, % ΔP_{Z}; (v) percent change in spring rate, % ΔSR_{Z}; and finally, (w) change in incremental shaft stroke, ΔL_{Z}.

The subscript: (a) W, D1, D2, D3, or S1 depicts the working tube, first dual function shaft, second dual function shaft, third dual function shaft, or single function shaft such that the symbol associated with the subscript represents the property of the working tube, first dual function shaft, second dual function shaft, third dual function shaft, or single function shaft; e.g., the subscript W depicts the working tube such that the symbol, D_{W}, represents the diameter of the working tube; (b) W1, W2, or W3 depicts the first, second, or third dual function shaft such that the symbol associated with the subscript represents the property of the first, second, or third dual function shaft; (c) t=1, 2, 3, or 4 whereby 1, 2, 3, or 4 depicts the first, second, third, or fourth stage such that the symbol associated with the subscript represents the property of the first, second, third, or fourth stage; (d) z=1e, 2f, 3g, or 4h whereby 1e, 2f, 3g, or 4h depicts the first, second, third, or fourth stage such that the symbol associated with the subscript represents the property of the first, second, third, or fourth stage; (e) X depicts the working tube such that L_{X} represents the length of the working tube; and (f) S1, S2, S3, or S4 depicts the first dual function shaft, second dual function shaft, third dual function shaft, or single function shaft such that L_{S1}, L_{S2}, L_{S3}, or L_{S4} represents the shaft stroke of the first dual function shaft, second dual function shaft, third dual function shaft, or single function shaft, respectively. The symbols in (e) and (f) are discussed below in step (2).

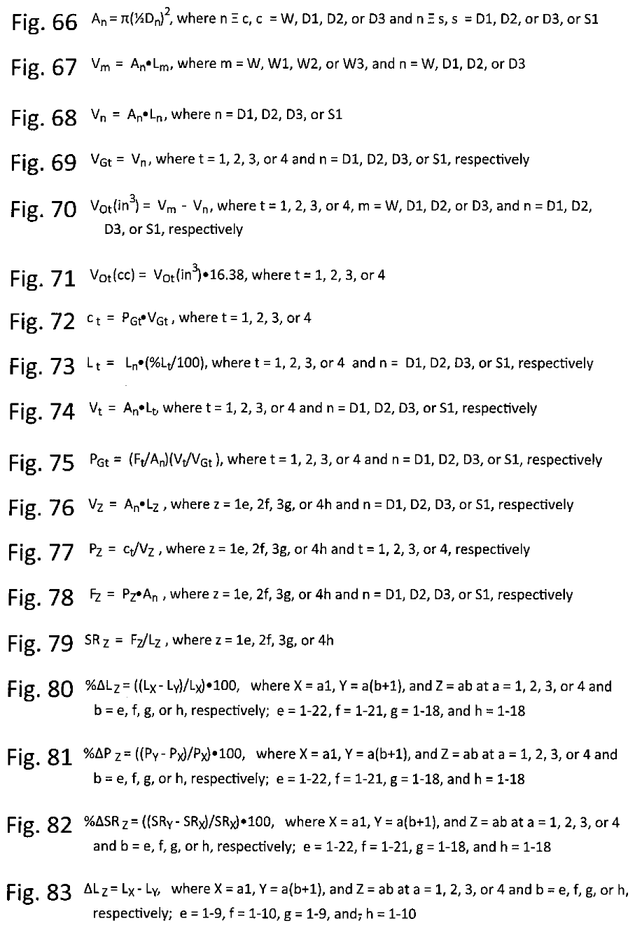

In the second step, values are selected for the following properties D_{W}, D_{D1}, D_{D2}, D_{D3}, D_{S1}, L_{W}, L_{W1}, L_{W2}, L_{W3}, L_{D1}, L_{D2}, L_{D3}, L_{S1}, F₁₋₄, and % L₁₋₄. These selected values are used in the equations shown in FIGS. 66-71 to compute the values for the following properties A_{W}, A_{D1}, A_{D2}, A_{D3}, A_{S1}, V_{W}, V_{W1}, V_{W2}, V_{W3}, V_{D1}, V_{D2}, V_{D3}, V_{S1}, V_{G1-4}, and V_{O1-4}. The selected values for L_{W}, L_{W1}, L_{W2}, L_{W3}, and L_{D1}, L_{D2}, L_{D3}, L_{S1}, are based on the computed values for L_{X}, L_{W1}, L_{W2}, L_{W3}, and L_{S1}, L_{S2}, L_{S3}, L_{S4}, respectively. The symbols L_{X}, L_{W1}, L_{W2}, L_{W3}, and L_{S1}, L_{S2}, L_{S3}, L_{S4}, and their respective computed values are defined in the first methodology discussed above. The selected and computed values are shown in FIGS. 84 and 85, respectively.

Third, the specified selected and computed values from FIGS. 84 and 85 are used in the equations shown in FIGS. 72-74 to compute the values for the following ride height properties: L₁₋₄, V₁₋₄, P_{G1-4}, whereby these values are shown in FIG. 86. Computed values for P_{G1-4}, and V_{G1-4}, are used in the equation shown in FIG. 75 to compute the values for Boyles' constants, C₁₋₄. Values for V_{G1-4} and C₁₋₄ are shown in FIG. 85. In particular, P_{G1-4} refers to the gas charge, and is the pressure of the gas necessary to support the suspension force at ride height, F₁₋₄, and set the shaft stroke at ride height, L₁₋₄, for each stage. The suspension force at ride height refers to part of the weight of the vehicle.

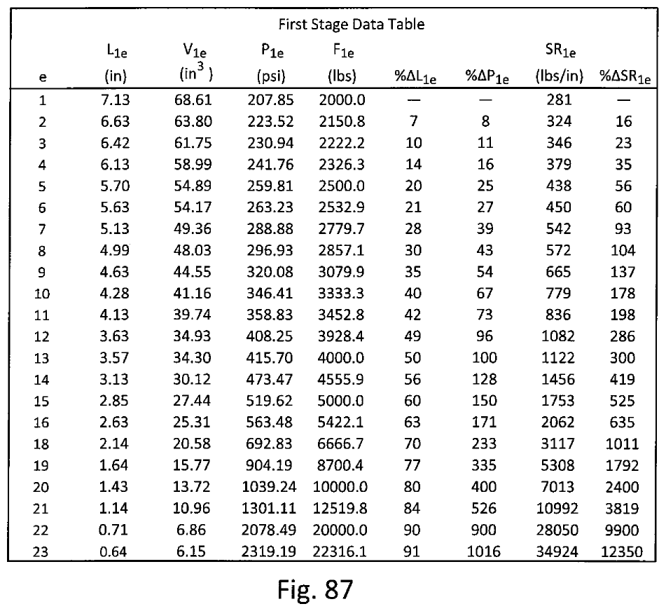

In the fourth step, the shaft stroke for each stage is divided up into incremental shaft strokes, L_{Z}, in order to reflect the operation of each stage from full extension to full compression or vice versa. In effect, the values for L_{Z} are selected. These selected values and specified computed values from FIG. 85 are used in the equations shown in FIGS. 76-82 to compute the values for the following properties at each L_{Z}: V_{Z}, P_{Z}, F_{Z}, SR_{Z}, % ΔL_{Z}, % ΔP_{Z}, % ΔSR_{Z}. These selected and computed values are shown in FIGS. 87-90.

Referring to FIGS. 87-90 for the fifth step, the values for L_{Z} are selected based on three objectives: (1) values are selected at 0.5 inch increments of the shaft stroke; (2) values are selected at 10% intervals of the shaft stroke, i.e., % ΔL_{Z}=10, 20, . . . 90; and (3) values are selected such that the suspension force at a given incremental shaft stroke for the fourth stage is the same as the minimum suspension force for the third stage, the suspension force at a given incremental shaft stroke for the third stage is the same as the minimum suspension force for the second stage, and the suspension force at a given incremental shaft stroke for the second stage is the same as the minimum suspension force for the first stage. In particular, objectives two and three facilitate plotting data on a graph.

Referring to FIG. 84 for the sixth step, a value for F₁₋₄ is selected in order to simulate one-fourth of the weight of the vehicle, while the values for % L₁₋₄ are selected to determine the shaft stroke for each stage at ride height. The selections prepare the four stage air shock to support the vehicle at ride height. In particular, selecting a different value for F₁₋₄ or % L₁₋₄ serves to compute a value for P_{G1-4} such that one interconnecting stage has undergone partial compression before the other interconnecting stage begins to compress. As a practical matter, for a given suspension force the smallest stage compresses the most, and the values for % L₁₋₄ increase in the following order: fourth stage<third stage<second stage<first stage. This order ensures that the curved lines for two interconnected stages intersect. The equation in FIG. 74, the method of selecting values for F₁₋₄ and % L₁₋₄, serves to compute the value for P_{G1-4} to set-up the four stage air shock.

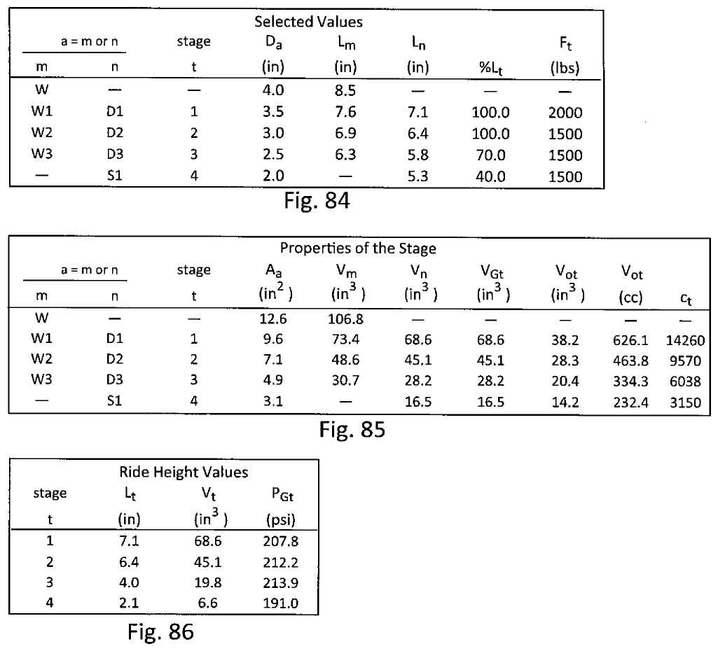

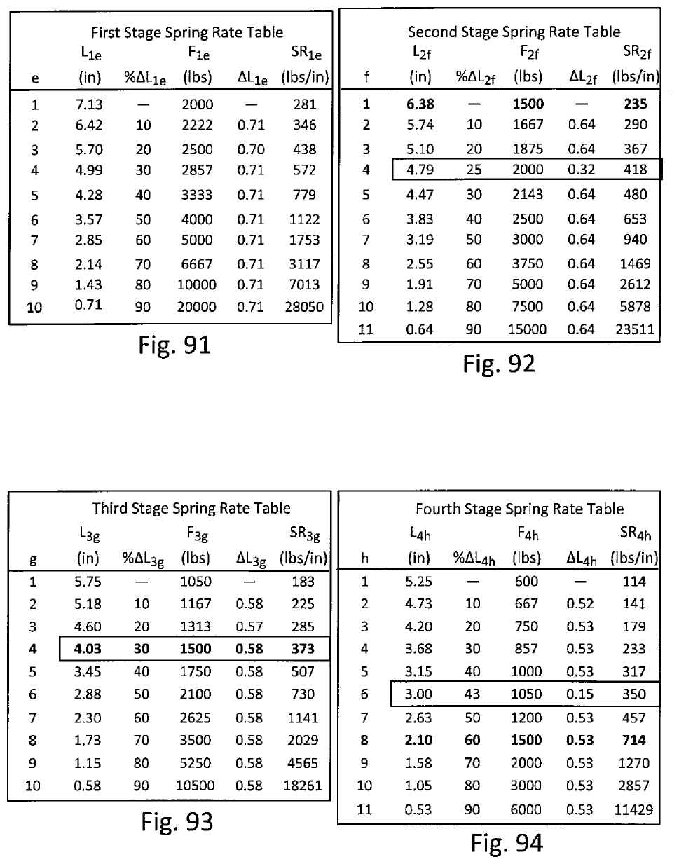

In the seventh step, the specified values for L_{Z}, % ΔL_{Z}, F_{Z}, SR_{Z} are copied from the data tables shown in FIGS. 87-90 to the spring rate tables shown in FIGS. 91-94. Additionally, values for L_{Z} are used in the equation shown in FIG. 83 to compute the values for ΔL_{Z}, whereby these computed values are shown in FIGS. 91-94. The values shown in FIGS. 91-94 serve as the basis for plotting four graphs. The values of F_{Z} and ΔL_{Z} for each stage are plotted on each graph, whereby the plot for each stage defines a curved line such that each graph consists of four curved lines, one curved line for each stage.

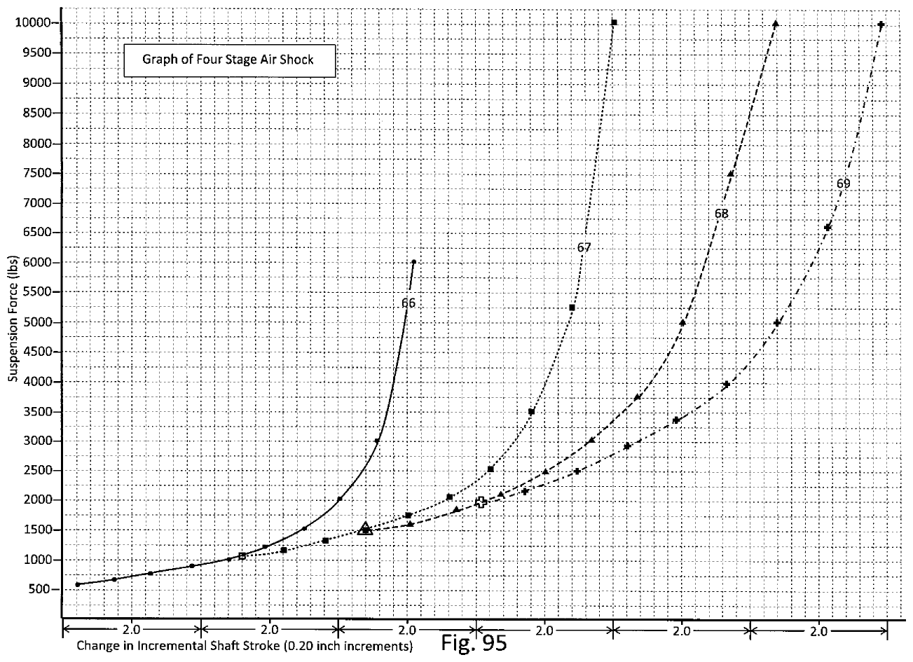

In the eighth step, the first graph refers to F_{Z} and ΔL_{Z} for each stage and is shown in FIG. 95. The F_{Z} is depicted on the vertical axis while ΔL_{Z} is depicted on the horizontal axis. In particular, ΔL_{Z} is plotted on the graph rather than L_{Z} in order to draw the curved line for each stage on a single graph. At the point of intersection between two interconnected stages, each interconnecting stage must have the same values for the properties defining the vertical and horizontal axes. At any given point of intersection, while two interconnected stages are able to have the same F_{Z}, they would also have a different L_{Z}. Therefore, if F_{Z} is the property defining the vertical axis, then L_{Z} cannot be the property defining the horizontal axis. In contrast, by defining the horizontal axis with ΔL_{Z}, then the two interconnected stages are able to have the same values for both F_{Z} and ΔL_{Z} at the point of intersection. The point of intersection between two interconnected stages is determined with F_{Z}, thereby establishing the graphical location where the two interconnected stages must have the same ΔL_{Z}. The data for the two interconnected stages are then plotted based on the point of intersection, whereby the data plot for one of the two interconnected stages begins at this point. The values of ΔL_{Z} for the axis are selected such that the difference between two values for the axis is greater than that between two plotted points for each stage.

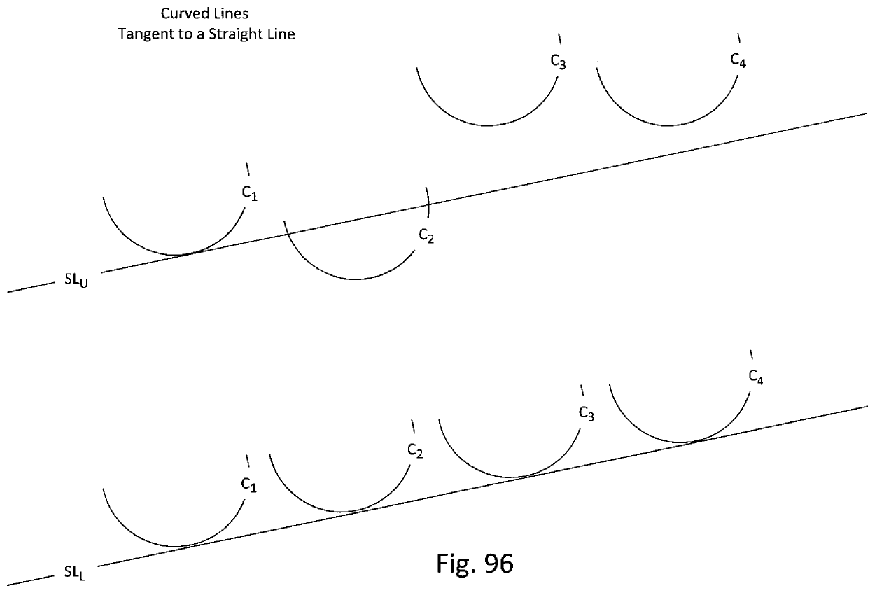

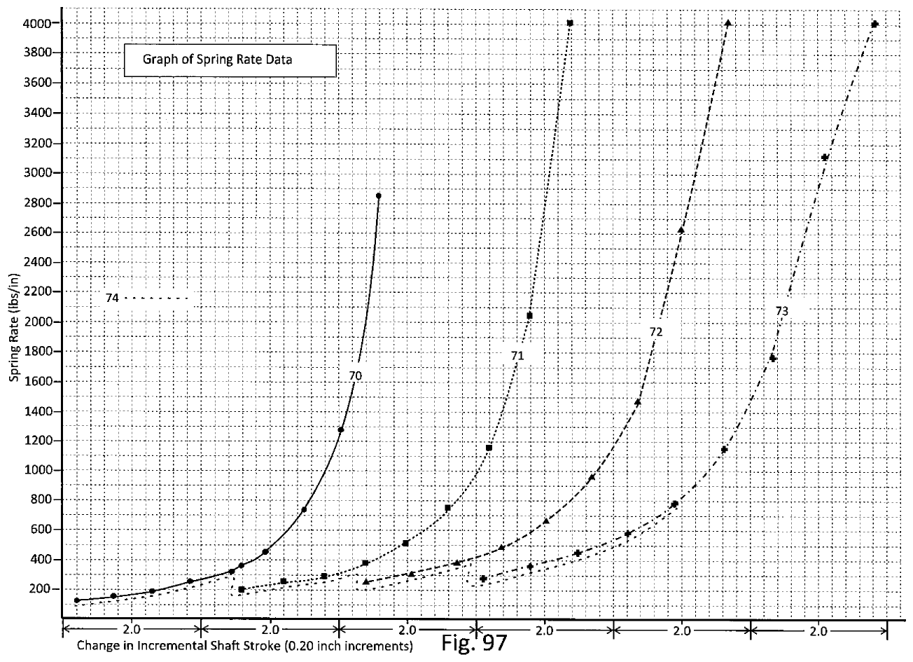

Referring to FIGS. 91-94, the values for F_{Z} and ΔL_{Z} are selected such that the curved lines for all four stages fit on a single graph. Since F_{Z} is computed in terms of F₁₋₄ and % L₁₋₄, then the values for F_{Z} are dependent on the values for F₁₋₄ and % L₁₋₄ whereby the selected values for F₁₋₄ and % L₁₋₄ locate the curve line for each stage on the graph, thereby determining where the curved line for one stage intersects that for the interconnected stage. The process of locating the curved lines for all four stages on the graph results in a series of four intersecting curved lines. Henceforth, the curve line for each stage refers to each curved line. The graphical location of each curved line refers to the alignment of each curved line. The intersection between the curved lines for two interconnected stages refers to the curved line part for one stage intersecting that for the interconnected stage whereby the graphical location of each curved line refers to the graphical location of each curved line part. The graphical location of each curved line part refers to where the curved line for one stage intersects that for the interconnected stage and thereby the alignment of each curved line part. Referring to FIG. 96, there is shown the principle of tangency whereby for the upper straight line SL_{U}, the first curved line C₁ is tangent to the upper straight line SL_{U} while the second, third, and fourth curved lines C₂₋₄ are not tangent to the upper straight line SL_{U} therefore the four curved lines C₁₋₄ have a low degree of tangency and are “non-aligned”; whereas for the lower straight line SL_{L}, the four curved lines C₁₋₄ are tangent to the lower straight line SL_{L} therefore the four curved lines C₁₋₄ have a high degree of tangency and are “aligned”. The degree of tangency to a straight line refers to the alignment of each curved line part whereby the straight line defines a tangency line. The first graph shows the following plots: the curved line 66 for the fourth stage intersects the low end of the curved line 67 for the third stage at a suspension force F₁₋₄ of 1050 lbs, the curved line 67 for the third stage intersects the low end of the curved line 68 for the second stage at a suspension force F₁₋₄ of 1500 lbs, and the curved line 68 for the second stage intersects the low end of the curved line 69 for the first stage at a suspension force F₁₋₄ of 2000 lbs.

In the ninth step, the second graph is shown in FIG. 97 and refers to SR₁₋₄ and ΔL_{Z} for each stage. The second graph is derived in the same manner as the first graph such that the values for SR_{Z} and ΔL_{Z} are plotted on the vertical and horizontal axes, whereby each point on each curved line is plotted on the second graph at the same ΔL_{Z} as that on the first graph shown in FIG. 95. After positioning each point for each stage according to SR₁₋₄, a curved line is drawn for each stage, whereby the two curved lines for each pair of interconnected stages do not intersect, thereby resulting in four independent non-intersecting curved lines on the graph. A lack of intersection among any two curved lines makes the four curved lines unsuitable for interpreting the spring rate for the four stage air shock on the basis of a single, smooth line; e.g., observe the thin, jagged dotted line 74 traced below the curved lines for the four stages.

In principle, the curved lines can be made to intersect in the same manner as that in the first graph shown in FIG. 95 by shifting the curved lines. Assume the curved line 70 for the fourth stage is the reference line, and then the curved lines for the first, second, and third stages 71, 72, and 73 are shifted until the low point of the curved line for third stage 71 intersects the curved line for the fourth stage 70, the low point of the curved line for second stage 72 intersects the curved line for the third stage 71, and the low point of the curved line for first stage 73 intersects the curved line for the second stage 72. The curved lines can be shifted in two ways. First, the curved lines can be shifted up by increasing the value of SR_{Z} at each point on each curved line. The value of SR_{Z} at each point on each curved line can be increased by increasing the values for SR₁₋₃ and/or % L₁₋₃. However, the values for SR₁₋₃ and/or % L₁₋₃ for each stage would have to be increased so much that the first, second, and third stages would not operate properly. For example, in order to shift the curved line for the third stage 71 up such that the low point of the curved line 71 intersects the curved line for the fourth stage 70, the spring rate at full extension for the third stage SR₃₁ would have to be 350 lbs/in. In order for SR₃₁ to be 350 lbs/in, then the values for F₃ and % L₃ would have to be equal to 2010 lbs and 100%, respectively. In effect, the third stage would operate similarly to the first stage. Second, the curved lines can be shifted to the left by shifting all points for each curved line to the left by the same amount. However, once the curved lines for the first, second, and third stages have been shifted to the left, the curved lines for the four stages would be so close together that interpreting the shape of a single smooth line that is traced along the curved line parts for the four stages is unreasonable. As a practical matter, the spring rate is based on an analysis of the graph derived from F_{Z} rather than that from SR_{Z}. Since the shapes of the four curved lines in the second graph are similar the those in the first graph, the spring rate for the four stage air shock is estimated on the basis of interpreting a single, smooth line from the four curved lines in the first graph.

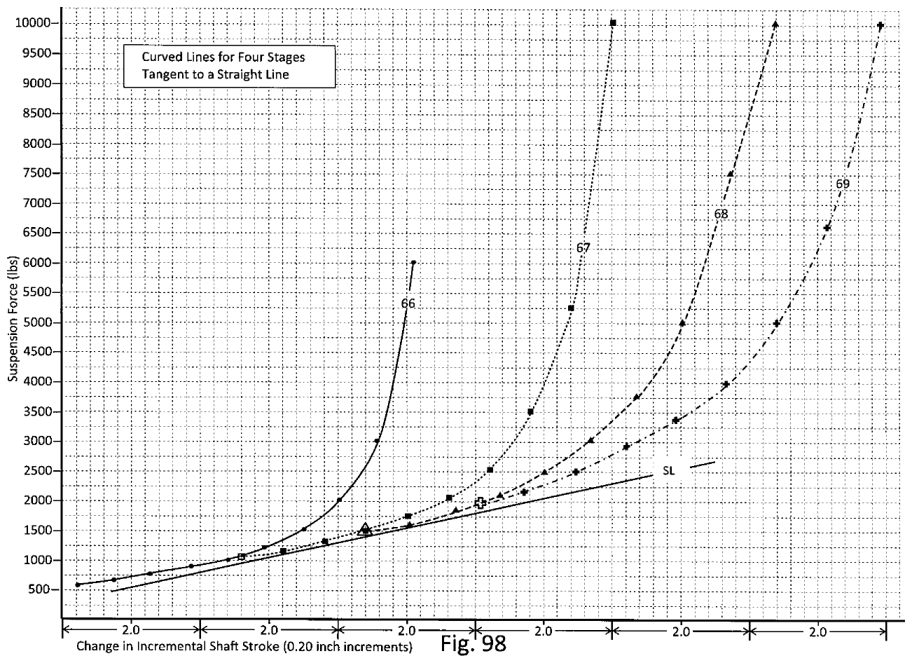

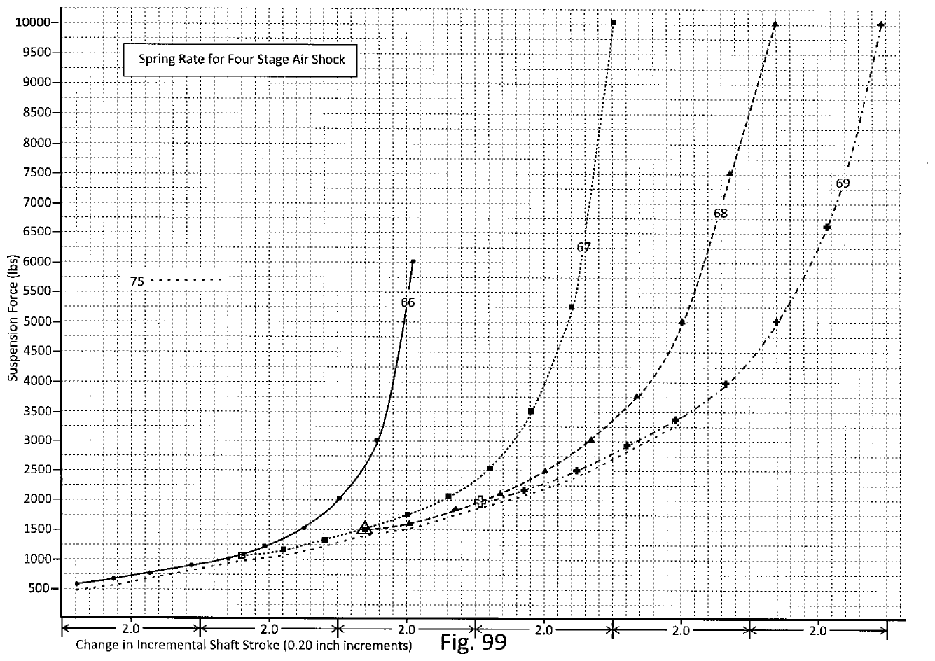

For the final step, the third and fourth graphs refer to a copy of the first graph that is shown in FIG. 95 whereby the third and fourth graphs are shown in FIGS. 98 and 99, respectively. Values for F₁₋₄ and % L₁₋₄ are selected in an iterative guess-and-check method until a line traced along the series of four intersecting curved line parts is relatively straight. Changing the selected values for F₁₋₄ and % L₁₋₄ changes the graphical location of each curved line part, whereby changing the graphical location of each curved line part changes where the curved line part for one stage intersects that for the interconnected stage, and thereby changes the alignment of each curved line part. In effect, the graphical location is changed until each curved line part is tangent to a straight line. Referring to FIG. 98, the curved lines for the four stages 66-69 are tangent to the straight line SL, thereby showing that each curved line part has a high degree of tangency, and therefore, is aligned. The alignment ensures that a relatively straight line is able to be traced along each curved line part. Referring to the graph in FIG. 99, a dotted line 75 is traced next to each curved line part, beginning at the low end of the curved line 66 for the fourth stage which is at F₁₋₄ of 600 lbs, along the curved line 66 for the fourth stage to the intersection with the low end of the curved line 67 for the third stage, then along the curved line 67 for the third stage to the intersection with the low end of the curved line 68 for the second stage, then along the curved line 68 for the second stage to the intersection with the low end of the curved line 69 for the first stage, then along the curved line 69 for the first stage and ending at a point on the curved line 69 for the first stage which is at F₁₋₄ of 3333 lbs. The dotted line trace 75 results in a single, smooth line that is also a relatively straight line. This relatively straight line represents an estimate of the spring rate for the four stage air shock.

Application of the second methodology for the four stage air shock involves the following ten steps.

The first step involves defining the following properties of each stage: the suspension force at ride height, Fₙ, percent of shaft stroke uncompressed at ride height, % Lₙ, suspension force, F_{Z}, shaft stroke, L_{D1}, L_{D2}, L_{D3}, L_{S1}, incremental shaft stroke, L_{Z}, gas pressure, P_{Z}, volume of the shaft, V_{Z}, change in incremental shaft stroke, ΔL_{Z}, gas charge, P_{Gn}, volume of the shaft at ride height, Vₙ, and shaft stroke at ride height, Lₙ.

The second step involves selecting values for the suspension force at ride height, Fₙ, percent of shaft stroke uncompressed at ride height, % Lₙ, shaft stroke, L_{D1}, L_{D2}, L_{D3}, L_{S1}, and incremental shaft stroke, L_{Z}, whereby the selected value for the shaft stroke, L_{D1}, L_{D2}, L_{D3}, L_{S1}, can be based on the value of the shaft stroke, L_{S1}, L_{S2}, L_{S3}, L_{S4}, that is computed with the first methodology as described above.

The third step involves computing a value for the suspension force, F_{Z}, as a product of a multiplication that is dependent on the incremental shaft stroke, L_{Z}, the dependency is defined by the multiplication including the gas pressure, P_{Z}, the gas pressure, P_{Z}, is computed as a quotient of a division that includes the volume of the shaft, V_{Z}, the volume of the shaft, V_{Z}, is computed as a product of a multiplication that includes the incremental shaft stroke, L_{Z}.

The fourth step involves computing a value for the change in incremental shaft stroke, ΔL_{Z}, as a difference of a subtraction between the incremental shaft stroke, L_{Z}, at one selected value and that at another selected value.

The fifth step involves computing a value for the gas charge, P_{Gn}, as a quotient of a division that includes the suspension force at ride height, Fₙ, and is dependent on the shaft stroke, L_{D1}, L_{D2}, L_{D3}, L_{S1}, and percent of shaft stroke uncompressed at ride height, % Lₙ. The dependency is defined by the division including the volume of the shaft at ride height, Vₙ, the volume of the shaft at ride height, Vₙ, is computed as a product of a multiplication that includes the shaft stroke at ride height, Lₙ, the shaft stroke at ride height, Lₙ, is computed as a product of a multiplication that includes the shaft stroke, L_{D1}, L_{D2}, L_{D3}, L_{S1}, and percent shaft stroke uncompressed at ride height, % Lₙ. In particular, the gas charge, P_{Gn}, determines the set-up for the four stage air shock.

The sixth step involves drawing a two-axis graph whereby the vertical axis is suspension force, F_{Z}, while the horizontal axis is a change in incremental shaft stroke, ΔL_{Z}.

The seventh step involves plotting the computed values for the suspension force, F_{Z}, and change in incremental shaft stroke, ΔL_{Z}, on the graph, whereby each plot defines a curved line. The curved line describes the operation of each stage such that a part of the curved line describes the part of the suspension spring capability that is utilized in the operation of each stage.

The eighth step involves selecting values for the suspension force at ride height, Fₙ, and percent of shaft stroke uncompressed at ride height, % Lₙ, to compute the gas charge, P_{Gn}, such that part of the suspension spring capability is utilized in the operation of each stage. The part of the suspension spring capability that is utilized in the operation of each stage is depicted by the fourth stage being partially compressed before the third stage begins to compress, the third stage being partially compressed before the second stage begins to compress, and the second stage being partially compressed before the first stage begins to compress. The fourth stage being partially compressed before the third stage begins to compress, the third stage being partially compressed before the second stage begins to compress, and the second stage being partially compressed before the first stage begins to compress are described on the graph as a series of four intersecting curved lines 66-69, one curved line for each stage. The series of four intersecting curved lines 66-69 can be depicted as a gradually sloping part of the curved line for the fourth stage 66 intersecting a gradually sloping part of the curved line for the third stage 67, the gradually sloping part of the curved line for the third stage 67 intersecting a gradually sloping part of the curved line for the second stage 68, and the gradually sloping part of the curved line for the second stage 68 intersecting a gradually sloping part of the curved line for the first stage 69, whereby the gradually sloping part of for one stage intersecting that for another stage defines a series of four intersecting curved line parts on the graph. Selecting values for the suspension force at ride height, Fₙ, and percent of shaft stroke uncompressed at ride height, % Lₙ, locates the gradually sloping part of each curved line on the graph. The location of the gradually sloping part of each curved line depicts an alignment of the gradually sloping part of each curved line. The alignment defines a given amount of tangency to a straight line, whereby the straight line defines a tangency line. The location of the gradually sloping part of each curved line defines where the gradually sloping part of the curved line for the fourth stage 66 intersects the gradually sloping part of the curved line for the third stage 67, where the gradually sloping part of the curved line for the third stage 67 intersects the gradually sloping part of the curved line for the second stage 68, and where the gradually sloping part of the curved line for the second stage 68 intersects the gradually sloping part of the curved line for the first stage 69. Changing the selected values for the suspension force at ride height, Fₙ, and percent of shaft stroke uncompressed at ride height, % Lₙ, changes where the gradually sloping part of the curved line for the fourth stage 66 intersects the gradually sloping part of the curved line for the third stage 67, where the gradually sloping part of the curved line for the third stage 67 intersects the gradually sloping part of the curved line for the second stage 68, and where the gradually sloping part of the curved line for the second stage 68 intersects the gradually sloping part of the curved line for the first stage 69 and thereby changes the alignment of the gradually sloping part of each curved line.

The ninth step involves changing the values for the suspension force at ride height, Fₙ, and percent of shaft stroke uncompressed at ride height, % Lₙ, in an iterative guess-and-check method in order to change the locations of the gradually sloping part of each curved line until the gradually sloping part of each curved line is aligned. The values for suspension force at ride height, Fₙ, and percent of shaft stroke uncompressed at ride height, % Lₙ, that serve to align the gradually sloping part of each curved line also determine the gas charge, P_{Gn}, to set-up the four stage air shock.

The final step involves tracing a line next to the gradually sloping part of each curved line whereby the line trace represents an estimate of the spring rate. Once the gradually sloping part of each curved line is aligned with the tangency line, then the line trace is substantially straight, thereby indicating a substantially linear spring rate for the four stage air shock.

Conclusions of the application of the second methodology for the four stage air shock include the following three observations.

First, the operation of the four stages is described as a series of four intersecting curved lines. The intersections among the four curved lines indicate that the entire progressive suspension spring capability of each stage is not utilized in the operation of each stage. Specifically, the intersection of the: (a) curved lines 67 and 66 for the third and fourth stages at the suspension force F₁₋₄ of 1050 lbs indicates that the fourth stage has been compressed to 57% of shaft stroke L₄ₕ before the third stage begins to compress, and results in the stiff part of the suspension spring capability for the fourth stage being avoided as the soft part of the suspension spring capability for third stage begins to react to the suspension force F₁₋₄; (b) curved lines 68 and 67 for the second and third stages at a suspension force F₁₋₄ of 1500 lbs indicates that the third stage has been compressed to 70% of shaft stroke L_{3g} before the second stage begins to compress, and results in the stiff part of the suspension spring capability for the third stage being avoided as the soft part of the suspension spring capability for second stage begins to react to the suspension force F₁₋₄; and (c) curved lines 69 and 68 for the first and second stages at a suspension force F₁₋₄ of 2000 lbs indicates that the second stage has been compressed to 75% of shaft stroke L_{2f} before the first stage begins to compress, and results in the stiff part of the suspension spring capability for the second stage being avoided as the soft part of the suspension spring capability for the first stage begins to react to the suspension force F₁₋₄. In effect, the curved line describes the suspension spring capability for each stage while a part of the curved line describes a part of the suspension spring capability for each stage. Since for all four stages the gradually sloping part of the curved line for one stage intersects that for the other interconnecting stage, then the soft part of the suspension spring capability is utilized in the operation of each stage;

Second, the combined effect of the suspension spring capabilities of the four stages defines the suspension spring capability of the four stage air shock, whereby the series of four intersecting curved lines describes the operation of the four stage air shock. Since each stage operates independently of the other stages, and since the suspension force exerted on each stage is the same, the shaft for each stage will move according to the part of each stage's suspension spring capability that is being utilized regardless of the movements by the shafts for the other stages. Given that the soft part of each stage's suspension spring capability is utilized in the operation of each stage, then only the soft part of each stage's suspension spring capability is utilized in the suspension spring capability of the four stage air shock. In effect, the suspension spring capability of the four stage air shock is defined by the combined effect of the soft part of each stage's suspension spring capability.

Finally, the second methodology allows a person to tune the multiple stage air shock. By adjusting the gas charge for each stage, a person can select which part of the progressive suspension spring capability will be utilized in the operation of each stage. For example, if the multiple stage air shock reacts too harshly against suspension forces, the gas charge for each stage can be decreased. The amount of the decrease in gas charge for each stage can be determined with the iterative guess-and-check method of selecting values for F₁₋₄ and % L₁₋₄. A graphical analysis of this decrease would appear as each plot intersecting at a point lower on the curved line for each stage—in effect the slope of the linear spring rate would be decreased. Conversely, if the multiple stage air shock reacts too softly against suspension forces, the gas charges for each stage can be increased, and the opposite analysis on a graph would appear.

Note: when referring to FIGS. 84-94, the properties and values listed therein are selected for purposes of discussion only and are not meant to imply proper values for any stage in a multiple stage air shock.

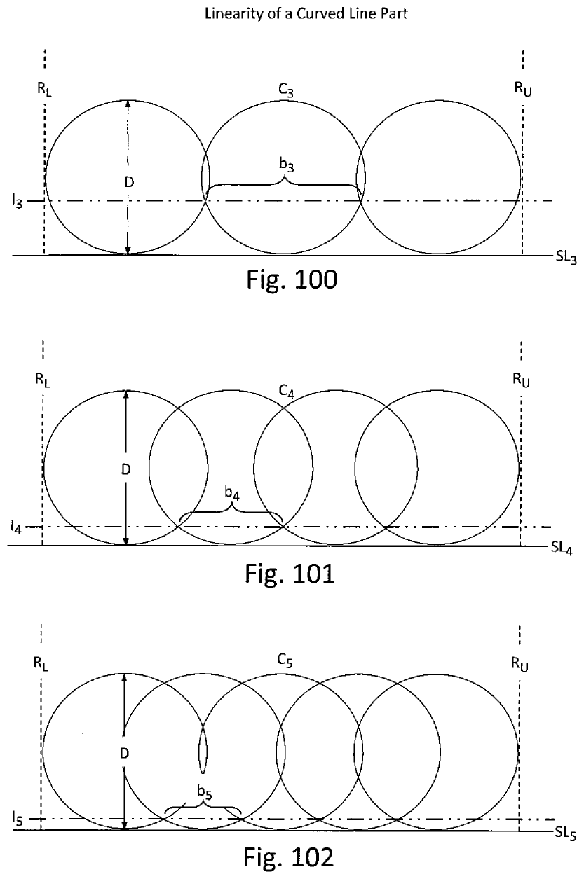

Referring to FIGS. 100-102, there is shown a means for changing the linearity of the spring rate for a three or four stage air shock, in this case emphasizing that the means can make the spring rate for the multiple stage air shock more linear, the means being an attribute of the second methodology.

Each figure illustrates a set of three, four, or five circles whereby each set represents a graphical description of the multiple stage air shock comprising three, four, or five stages, respectively. The three, four, or five circles in each set are represented by C₃₋₅, whereby each circle defines the curved line for each stage in the three, four, or five stage air shock, respectively. Each circle in each set intersects the adjacent circle such that each set of three, four, or five circles defines a series of three, four, or five intersecting curved lines, respectively. The set of four circles represents a graphical description of adding a new first stage to the three stage air shock such that a new first curved line is added to a series of three intersecting curved lines thereby transforming the series of three intersecting curved lines into a series of four intersecting curved lines; while the set of five circles represents a graphical description of adding a new first stage to the four stage air shock such that a new first curved line is added to a series of four intersecting curved lines thereby transforming the series of four intersecting curved lines into a series of five intersecting curved lines.

Each circle has the same diameter D, and the circles in each set are aligned both horizontally and vertically. The horizontal solid lines SL₃₋₅ refer to tangency lines while the vertical dashed lines R_{L} and R_{U} refer to a given range of the change in incremental shaft stroke whereby each set of circles occupy the same range. The horizontal dashed line l₃₋₅ in each set of circles shows where each circle in a set intersects the adjacent circle, thereby indicating the distance between the two points of intersection on each circle. The distance between the two points of intersection on each circle is represented by the bracket b₃₋₅. The bracket b₃₋₅ depicts a part of each circle such that the part of each circle defines the curved line part for each stage whereby the curved line part for each stage describes the part of the suspension spring capability that is utilized in the operation of each stage.

Inspection of the sets of circles reveals that as the number of circles increases from three to four to five, then the size of the brackets b₃₋₅ decreases, thereby depicting that the distance between the two points of intersection on each circle also decreases. Since: (a) each circle has the same diameter, then the decrease in the distance between the two points of intersection on each circle is not due to a change in the curvature of each circle; and (b) set of circles occupy the same range of the change in incremental shaft stroke, then the decrease in the distance between the two points of intersection on each circle is not due to squeezing the circles closer together by decreasing the range. Instead of (a) or (b), the decrease in the distance between the two points of intersection on each circle is due to increasing the number of circles within the range, whereby the increase acts to squeeze the circles closer together in order to fit within the range. Squeezing the circles closer together moves the two points of intersection on each circle closer to the tangency line SL₃₋₅, whereby this movement causes a decrease in the distance between the horizontal dashed line l₃₋₅ and tangency line SL₃₋₅.

The decrease in the size of each bracket b₃₋₅ indicates that the part of each circle is less curved whereby less curved is depicted as flatter. This flattening of the part of each circle is confirmed by the decrease in the distance between the horizontal dashed line l₃₋₅ and tangency line SL₃₋₅ for each set of circles. The flattening of the part of each circle indicates that the curved line part for each stage becomes flatter. A flatter curved line part for each stage indicates a decrease in the part of the suspension spring capability that is utilized in the operation of each stage, and that the curved line part is less curved, i.e., straighter. Since the curved line part for each stage becomes straighter, then a line that is traced over the curved line part for each stage would become straighter and thereby indicate that the spring rate for the multiple stage air shock becomes more linear, i.e., straighter with the addition of another stage. In effect, the decrease in the part of the suspension spring capability that is utilized in the operation of each stage indicates that a smaller part of the progressive spring rate for each stage contributes to the spring rate for the multiple stage air shock. This analysis also suggests that, assuming other factors are equivalent, for a given multiple stage air shock, the spring rate can be made more linear as the number of stages increases.

While the invention has been illustrated and described as a multiple stage shock absorber, it is not intended to be limited to the details shown, since it will be understood that various omissions, modifications, substitutions and changes in the forms and details of the device illustrated and, in its operation, can be made by those skilled on the art without departing in any way from the scope and spirit of the present invention.

What is claimed is:

1. A multiple stage air shock, comprising:
a cylindrical first stage shock that has a closed first proximal end and a first distal end that narrows into a first shank and a first piston that is mounted onto the first shank;
an at least one cylindrical interconnecting stage shock that has an open interconnected proximal end and a closed interconnected end that narrows to form an interconnected shank and an interconnected piston that is mounted onto said interconnected shank;
a cylindrical final stage air shock that has a closed open final proximal end and a closed final distal end;
wherein first distal end of said first stage is slidably inserted into said interconnected open proximal end,
wherein said closed distal interconnected end is slidably inserted into said open final proximal end.

2. The multiple stage air shock of claim 1, wherein the insertion of first stage shock into at least one interconnected stage shock creates a first confined space that contains both gas and oil.

3. The multiple stage air shock of claim 2, wherein the insertion of at least one interconnected shock into the final stage air shock creates a second confined space that contains both gas and oil.

4. The multiple stage air shock of claim 3, wherein the gas in the first confined space has a first predetermined charge to provide a first suspension spring force.

5. The multiple stage air shock of claim 4, wherein the oil in the first confined space passed through the first piston at a predetermined rate to provide a first dampening.

6. The multiple stage air shock of claim 5, wherein the gas in the final confined space has a second predetermined charge to provide a second suspension spring force.

7. The multiple stage air shock of claim 6, wherein the oil in the second confined space passes through the at least one interconnected piston at a predetermined rate to provide a second dampening.

8. The multiple stage air shock of claim 7, wherein the first suspension spring force, second suspension spring force, the first dampening, and second dampening are coordinated to provide the multiple stage air shock with coordinated dampening and suspension spring forces.
